(19) United States
(12) Patent Application Publication
(10) Pub. No.: US 2007/0058725 A1
(43) Pub. Date: Mar. 15, 2007

(54) CODING/DECODING APPARATUS, CODING/DECODING METHOD, CODING/DECODING INTEGRATED CIRCUIT AND CODING/DECODING PROGRAM

(75) Inventors: Masayasu IGUCHI, Osaka (JP); Masayoshi TOUJIMA, Osaka (JP); Kiyofumi ABE, Osaka (JP); Jun TAKAHASHI, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/531,008

(22) Filed: Sep. 12, 2006

(30) Foreign Application Priority Data
Sep. 13, 2005 (JP) 2005/266095

(51) Int. Cl. H04N 11/04; H04N 5/91

(52) U.S. Cl. 375/240.23; 386/46

(57) ABSTRACT

The coding/decoding apparatus which performs coding and decoding at the same time includes: (a) a variable length coding unit which performs, on input data, variable length coding which does not include arithmetic coding, so as to generate first-type stream data; (b) an arithmetic coding unit which performs arithmetic coding on the first-type stream data so as to generate second-type stream data; (c) a first recording area in which the second-type stream date is recorded; and (d) a variable length decoding unit which performs, on the first-type stream data, variable length decoding for decoding a data format of the first-type stream data into a data format applied before the variable length coding is performed, so as to generate output data.

### BACKGROUND OF THE INVENTION

(1) Field of the Invention

The present invention relates to a coding/decoding apparatus which performs recording and reproduction at the same time in the case of using arithmetic coding or the like.

(2) Description of the Related Art

Recently, with the arrival of the age of multimedia in which audio, video and other pixel values are integrally handled, existing information media, i.e., newspapers, journals, TVs, radios, telephones and other means through which information is conveyed to people, has come under the scope of multimedia. Generally speaking, multimedia refers to something that is represented by associating not only characters but also graphics, audio and especially images and the like. Expressing the aforementioned existing information media in digital form is prerequisite to including such information in the scope of multimedia.

However, when estimating the amount of information contained in each of the aforementioned information media as an amount of digital information, the information amount per character requires 1-2 bytes, whereas audio requires more than 64 Kbits per second (telephone quality); and furthermore, moving pictures require more than 100 Mbits per second (present television reception quality). Therefore, it is not practical to handle the vast amount of 3c) information directly in the digital format via the information media mentioned above. For example, a videophone has already been put into practical use via Integrated Services Digital Network (ISDN) with a transmission rate of 64 Kbits/s-1.5 Mbits/s; however, it is not practical to transmit video captured on the TV screen or filmed by a camera.

This therefore requires information compression techniques, and for instance, in the case of the videophone, video compression techniques compliant with H.261 and H.263 standards recommended by ITU-T (International Telecommunication Union-Telecommunication Standardization Sector) are employed.

According to the information compression techniques compliant with the MPEG-1 standard, image information can be stored together with music information in an ordinary music CD (Compact Disc).

Here, MPEG (Moving Picture Experts Group) is an international standard for compression of moving picture signals standardized by ISO/IEC (International Standards Organization/International Electrotechnical Commission), and MPEG-1 is a standard to compress video signals down to 1.5 Mbits/s, that is, to compress information of TV signals approximately down to a hundredth. The transmission rate within the MPEG-1 standard is set to about 1.5 Mbits/s for a picture of medium quality; therefore, MPEG-2 which was standardized with the view to meet the requirements of high-quality picture allows data transmission of moving picture signals at a rate of 2-15 Mbits/s to achieve TV broadcast quality. In the present circumstances, a working group (ISO/IEC ITC1/SC29/WG11) in charge of the standardization of MPEG-1 and MPEG-2 has achieved a compression rate which goes beyond what MPEG-1 and MPEG-2 have achieved, and has further enabled coding/decoding operations on a per-object basis and standardized MPEG-4 in order to realize a new function necessary in the era of multimedia. In the process of the standardization of MPEG-4, the standardization of a low-bit-rate coding method was aimed; however, the aim has been extended to include a more versatile encoding of moving pictures at a high bit rate including interlaced pictures.

Moreover, in 2003, MPEG-4 AVC and H.264 have been standardized as picture coding systems with higher compression rate through an ISO/IEC and ITU-T joint project (see ISO/IEC 14496-10, International Standard: “Information technology-Coding of audio-visual objects—Part 10: Advanced video coding” (2004-10-01)). The H.264 standard has been extended to include a modified specification that is High Profile compatible, which is suitable for High Definition (HD) video. It is expected that the H.264 standard will be applied in a wide range of uses such as digital broadcasting, Digital Versatile Disk (DVD) player/recorder, hard disk players/recorders, camcorders, videophones, or the like, as with MPEG-2 and MPEG-4.

In general, in coding a moving picture, compressing the amount of information is performed by eliminating redundancy both in temporal and spatial directions. Therefore, inter-picture prediction coding, which aims to reduce the temporal redundancy, estimates a motion and generates a predictive picture on a block-by-block basis with reference to forward and backward pictures, and then codes a differential value between the obtained predictive picture and a current picture to be coded. Here, “picture” is a term used to express a single image; and “picture” expresses a frame when used for a progressive picture, whereas “picture” expresses a frame or a field when used for an interlaced picture. An interlaced picture is a picture in which a single frame consists of two fields respectively having different time, Three methods are possible for coding and decoding an interlaced picture: processing a single frame either as a frame, as two fields, or as a frame structure/field structure depending on a block in the frame.

A picture on which intra-picture prediction coding is performed without reference pictures is called an “I-picture”. A picture to which an inter-picture prediction coding is performed with reference to a single picture is called a “P-picture”. A picture to which the inter-picture prediction coding is performed by referring simultaneously to two pictures is called a “B-picture”. A B-picture can refer to two pictures, arbitrarily selected from the pictures a whose display time is either forward or backward to that of a current picture to be coded, as an arbitrary combination. The reference pictures can be specified for each block which is a basic coding unit, but they can be classified as follows: a first reference picture is a reference picture that is denoted first in the bit stream on which coding is performed; and a second reference picture is a picture that is described later than the first reference picture. However, the reference pictures need to be already coded, as a condition to code the I, P and B pictures.

Motion compensation inter-picture prediction coding is employed for coding P-pictures or B-pictures. Motion compensation inter-picture prediction coding is a coding method in which motion compensation is applied to the inter-picture prediction coding. The motion compensation is not simply a method for predicting motions using pixels in the reference picture, but for estimating an amount of motion (hereinafter referred to as “motion vector”) for each part within a picture and improve prediction accuracy by performing prediction that takes an estimated amount of motion into consideration as well as to reduce the data amount. For example, the amount of data is reduced by estimating motion vectors for a current picture to be coded and by coding a prediction error between the current picture and a predictive value, which is obtained after a shift for the amount equivalent to the motion vector. In the case of using this method, information on motion vectors is required at the time of decoding; therefore, the motion vectors are coded and then recorded or transmitted.

A motion vector is estimated on a macroblock-by-macroblock basis, To be precise, the motion vector is estimated by fixing a macroblock in a current picture to be coded, shifting a macroblock in a reference picture within a search range, and then finding out a location of a reference block that resembles a basic block the most.

FIGS. 1 and 2 are block diagrams showing the configurations of a conventional coding/decoding apparatus. In FIG. 2, the same referential codes are provided for the same components as those shown in FIG. 1.

As shown in FIG. 1, the coding/decoding apparatus (coding function) 10 that operates for coding is configured of a motion detection unit 11, a multi-frame memory 12, subtractors 13 and 14, a motion compensation unit 15, a coding unit 16, an adder 17, a motion vector memory 18, and a motion vector estimation unit 19.

The motion detection unit 11 compares an image signal 32 with a motion-estimated reference pixel 31 outputted from the multi-frame memory 12, and outputs a motion vector 33 and a reference frame number 34. The reference frame number 34 is an identification signal that identifies a reference picture to be referred to for a target picture and that is selected from plural reference pictures. The motion vector 33 is temporarily stored in the motion vector memory 18, outputted as a neighborhood motion vector 35, and then used as a neighborhood motion vector 35 which is referred to by the motion vector estimation unit 19 for predicting a predictive motion vector 36. The subtractor 14 subtracts the predictive motion vector 36 from the motion vector 33, and outputs the resulting difference as a motion vector predictive difference 37.

On the other hand, the multi-frame memory 12 outputs a pixel indicated by the reference frame number 34 and the motion vector 33, as a motion-compensated reference pixel 38, and the motion compensation unit 15 generates a reference pixel with decimal precision and outputs a reference image pixel 39. The subtractor 13 subtracts the reference image pixel 39 from the image signal 32, and outputs an inter-picture prediction error 40.

The coding unit 16 variable-length codes the inter-picture prediction error 40, the motion vector predictive difference 37 and the reference frame number 34, and outputs a coded signal 41.

Note that, in the coding, a decoded inter-picture prediction error 42 resulting from the decoding of the inter-picture prediction error 40 is also outputted at the same time. The decoded inter-picture prediction error 42 is obtained by superimposing a coded error on the inter-picture prediction error 40, and matches with an inter-picture prediction error resulting from the decoding of the coded signal 41 performed by the coding/decoding apparatus 10 (decoding function).

The adder 17 adds the decoded inter-picture prediction error 42 to the reference image pixel 39, and stores the resultant as a decoded image 43 into the multi-frame memory 12. However, in order to effectively use the capacity of the multi-frame memory 12, an area of the image stored in the multi-frame memory 12 is released when unnecessary, whereas the decoded image 43 that is the image which does not need to be stored in the multi-frame memory 12 is not stored in the multi-frame memory 12.

As shown in FIG. 2, the coding/decoding apparatus (decoding function) 10 that operates for decoding is configured of the multi-frame memory 12, the motion compensation unit 15, the adder 17, the motion vector estimation unit 19, a decoding unit 20, and an adder 21. Such coding/decoding apparatus (decoding function) 10 decodes the coded signal 41 generated by coding performed by the coding/decoding apparatus (coding function) 10 that operates for coding (see FIG. 1), and outputs a coded image signal 44.

The decoder 20 decodes the coded signal 41, and outputs the decoded inter-picture prediction error 42, the motion vector predictive difference 37, and the reference frame number 34. The adder 21 adds the motion vector predictive difference 37 to the predictive motion vector 36 outputted from the motion vector estimation unit 19, and decodes the motion vector 33.

The multi-frame memory 12 outputs the reference frame number 34 and the pixel indicated by the motion vector 33 as a motion-compensated reference pixel 38. The motion compensation unit 15 generates a reference pixel with fraction pixel accuracy, and outputs a reference image pixel 39. The adder 17 adds the decoded inter-picture prediction error 42 to the reference image pixel 39. The result of the addition is stored as the decoded image 43 into the multi-frame memory 12. However, in order to effectively use the capacity of the multi-frame memory 12, the area of the image stored in the multi-frame memory 12 is released when that area is unnecessary. The decoded image 43 that is the image which does not need to be stored in the multi-frame memory 12 is not stored in the multi-frame memory 12. As described above, it is possible to properly decode the decoded image signal 44, that is, the decoded image 43, from the coded signal 41.

According to the H.264 standard, arithmetic coding (CABAC: Context-based Adaptive Binary Arithmetic Coding) may be used in the variable length coding performed in the coding unit 16. Similarly, the arithmetic coding can also be used for inverse transformation (hereinafter referred to as “variable length decoding”) of the variable length coding performed in the decoder 20 (see FIG. 2). However, in the case of using the arithmetic coding, sequential processing per bit that constitutes syntax is required as its attribute. Here, syntax is, for instance, the inter-picture prediction error 40, the motion vector predictive difference 37 and the reference frame number 34 shown in FIGS. 1 and 2. Therefore, in the case of using arithmetic coding, it is necessary, in a sequence of streams, to perform operation speculatively while predicting the result of the sequential processing, in order to fully exercise the performance compliant with a decoding specification, although averagely little operation resource is required. This causes a problem that a vast amount of operation resources is required for that.

In contrast, in order to prevent such huge operation resources, a limit monitor which monitors the data amount or binary data to be inputted to an arithmetic decoder, and a technology to perform error processing in the case where the data amount exceeds a certain amount within a certain coding unit (see Japanese Laid-Open Application No. 2004-135251).

Recently, the functions such as “chasing playback” or “time-shifted playback”, by which it is possible to continue recording a TV program while playing back the TV program that is presently being recorded from the beginning without waiting for the termination of the recording, are installed in a recording and reproduction apparatus using a random-accessible device (e.g. a DVD and an HOD). The advantage of these functions is that it is possible for the user to immediately start watching a TV program whenever he/she desires without waiting for the termination of the recording. For example, by reproducing a TV program while skipping commercials or reproducing a TV program with a slightly higher speed as 1 to 1.5 times as fast as the normal speed, it is possible to eventually catch up with the broadcast of the program even though the time to start watching the program is delayed. It is surely possible to stop the playback of the program in the middle and watch the rest of the program later, and such functions are thus convenient for effectively using limited time. Such a technology has not been enabled with Video Home System (VHS) videocassette recorders and tape media, and is gathering attention for its special replay uniquely operated using a random-accessible HDD and DVD.

In the chasing playback as described above, recording processing is carried out during reproduction processing in parallel or seemingly in parallel by use of time sharing. Once the reproduction operation is started, a stream is read out from a high-capacity storage device such as a DVD and an HDD, and variable length decoding is performed or the read-out stream.

However, in the case of using arithmetic coding such as CABAC in a recording and reproduction apparatus (e.g. a DVD/HDD recorder) compliant with the H.264 standard, there is a problem that a reproduction time cannot catch up with a recording time.

For example, as shown in FIGS. 3A and 3B, it is assumed that the state in which a recording time and a reproduction time are distant from each other (see FIG. 3A) is shifted to the state in which the reproduction time is closer to the recording time as much as possible (see FIG. 3B) during the chasing playback of pictures in a certain video sequence. Here, to make the story simple, time 52 to end pre-processing of the arithmetic coding and time 52 to start the arithmetic coding, in the variable length coding processing, are adjusted to he the same.

Similarly, in the variable length decoding, time 62 to end arithmetic decoding and time 62 to start post-processing of the arithmetic decoding are adjusted to be the same. The time required for transmission (from time 53 to time 61) is assumed to be 0.

In this case, since arithmetic coding is used in the variable length coding and decoding, inevitable sequential processing is included therein, Therefore, as for the processing before and after the use of the arithmetic coding, it is more or less possible to reduce time, but in the processing using the arithmetic coding, it is extremely difficult to reduce time. As a result, it is very difficult to reduce time down to a time period between time 71 to time 76, or less, as shown in FIG. 3B. More precisely, it is assumed that coding and decoding are performed with a maximum capacity of a Coding Picture buffer (CPB) at 62.5 Mbits and a maximum bit rate of 50 Mbps, and that the performance of the variable length coding/decoding which includes arithmetic coding is implemented at 50 Mbps in accordance with the maximum bit rate, The additional arithmetic coding causes a delay in total of 2.5 seconds: 1.25 seconds in the coding; and 1.25 seconds in the decoding. In fact, a delay due to an access to a high-capacity storage device is additionally caused, which results in a delay longer than the estimated one.

Namely, in the case of performing variable length coding using arithmetic coding such as CABAC compliant with the H.264 standard, when operating chasing playback (or time-shifted playback) by performing coding and decoding of the moving pictures at the same time or seemingly at the same time using time sharing, a problem is that a reproduction time can not catch up with a recording time.

As indicated in the ISO/IEC 14496-10, International Standard: “Information technology-Coding of audio-visual objects —Part 10: Advanced video coding” (2004-10-01), although it is possible to alleviate the problem more or less by increasing a circuit scale and inserting error processing, this in turn causes another problem, that is, the increase in a circuit scale.

### SUMMARY OF THE INVENTION

The present invention is conceived in view of the above problems, and an object of the present invention is to provide a coding/decoding apparatus which can realize chasing playback without huge investment on circuit.

In order to achieve the abovementioned object, the coding/decoding apparatus according to the present invention is a coding/decoding apparatus which performs coding and decoding at the same time, and includes: a first-type variable length coding unit which performs first-type variable length coding on input data so as to generate first-type stream data, the first-type variable length coding not including an arithmetic coding process; a second-type variable length coding unit which performs second-type variable length coding on the first-type stream data so as to generate second-type stream data, the second-type variable length coding being different from the first-type variable length coding; a first recording unit which records the second-type stream data into a first recording area; and a first-type variable length decoding unit which performs first-type variable length decoding on the first-type stream data so as to generate output data, the first-type variable length decoding being for decoding the first-type stream data into a data format applied before the first-type variable length coding is performed.

The coding/decoding apparatus may further include a first buffer memory unit which stores the first-type stream data generated by the first-type variable length coding unit, wherein the first-type variable length decoding unit may perform the first-type variable length decoding on the first-type stream data stored in the first buffer memory unit.

The coding/decoding apparatus may further include a second recording unit which records the first-type stream data stored in the first buffer memory unit into a second recording area; and a second buffer memory unit which stores the first-type stream data recorded in the second recording area, wherein the first-type variable length decoding unit may perform the first-type variable length decoding on the first-type stream data stored in one of the first buffer memory unit and the second buffer memory unit.

This makes it possible to extract an intermediate stream and is once stored in a high-capacity storage device such as a DVD and an HDD and to omit a sequential process such as arithmetic coding/decoding, even if a recording time and a reproduction time are slightly distant from each other. Therefore, it is possible to reduce the amount of data exchange with a buffer as well as to display a reproduction screen until the reproduction time catches up with the recording time.

The coding/decoding apparatus may further include, a second-type variable length decoding unit which performs second-type variable length decoding on the second-type stream data so as to generate first-type stream data, the second-type variable length decoding being for decoding the second-type stream data into a data format applied before the second-type variable length coding is performed; and a third buffer memory unit which stores the first-type stream data generated by the second-type variable length decoding unit, wherein the first-type variable length decoding unit may perform the first-type variable length decoding on the first-type stream data stored in one of the first buffer memory unit, the second buffer memory unit and the third buffer memory units

The structure as described above enables extraction of an intermediate stream and is stored in a high-capacity storage device such as a DVD and an HDD and omission of a sequential process such as arithmetic coding/decoding, even if a recording time and a reproduction time are slightly distant from each other, Therefore, it is possible to reduce the amount of data exchange with a buffer as well as to display a reproduction screen until the reproduction time catches up with the recording time.

The coding/decoding apparatus may further include a selection unit which selects a supplier of the first-type stream data inputted into the first-type variable length decoding unit; and a selection control unit which causes the selection unit to select a supplier based on a temporal relationship between a recording time and a reproduction time.

The selection control unit may cause the selection unit (a) to select the third buffer memory unit as the supplier when reproduction processing is started during recording processing, (b) to select the second buffer memory unit as the supplier as the reproduction time approaches to the recording time, and (c) to select the first buffer memory unit as the supplier as the reproduction time further approaches the recording time.

Thus, by using a stream format that does not include a sequential process such as arithmetic coding/decoding instead of a final stream for a stream used in chasing playback, the amount of data exchange with a buffer can be reduced and a reproduction time can catch up with a recording time.

The coding/decoding apparatus may further include: a second-type variable length decoding unit which performs second-type variable length decoding on the second-type stream data so as to generate the first-type stream data, the second-type variable length decoding being for decoding a data format of the second-type stream data into a data format applied before the second-type variable length coding is performed; and a second buffer memory unit which stores the first-type stream data generated by the second-type variable length decoding unit wherein the first-type variable length decoding unit may perform the first-type variable length decoding on the first-type stream data stored in one of the buffer memory unit and the second buffer memory unit.

This makes it possible to extract an intermediate stream and is once stored in a high-capacity storage device such as a DVD and an HDD and to omit a sequential process such as arithmetic coding/decoding, even if a recording time and a reproduction time are slightly distant from each other. Therefore, it is possible to reduce the amount of data exchange with a buffer as well as to display a reproduction screen until the reproduction time catches up with the recording time.

The coding/decoding apparatus may further include: a second recording unit which records the first-type stream data into a second recording area; and a first buffer memory unit which stores the first-type stream data recorded in the second recording area, wherein the first-type variable length decoding unit may perform the first-type variable length decoding on the first-type stream data stored in the first buffer memory unit.

The coding/decoding apparatus may further include: a second-type variable length decoding unit which performs second-type variable length decoding on the second-type stream data so as to generate first-type stream data, the second-type variable length decoding being for decoding the second-type stream data to obtain a data format applied before the second variable length coding is performed; and a second buffer memory unit which stores the first-type stream data generated by the second-type variable length decoding unit, wherein the first-type variable length decoding unit may perform the first-type variable length decoding on the first-type stream data stored in one of the first buffer memory unit and the second buffer memory unit.

The structure as described above enables extraction of an intermediate stream and is stored in a high-capacity storage device such as a DVD and an HDD and omission of a sequential process such as arithmetic coding/decoding, even if a recording time and a reproduction time are slightly distant from each other. Therefore, it is possible to reduce the amount of data exchange with a buffer as well as to display a reproduction screen until the reproduction time catches up with the recording time.

The second-type variable length coding unit may perform, per unit, sequential processing as the second-type variable length coding, the unit being smaller than a coded symbol that constitutes the first-type stream data.

This makes it possible to extract an intermediate stream and is once stored in a high-capacity storage device such as a DVD and an HDD and to omit a sequential process such as arithmetic coding/decoding, even if a recording time and a reproduction time are sightly distant from each other, Therefore, it is possible to reduce the amount of data exchange with a buffer as well as to display a reproduction screen until the reproduction time catches up with the recording time.

The coding/decoding apparatus may further include: a third-type variable length coding unit which performs third-type variable length coding on input data so as to generate third-type stream data, the third-type variable length coding not requiring the sequential processing; a third recording unit which records the third-type stream data generated by the third-type variable length coding unit into a third recording area; and a third-type variable length decoding unit which performs third-type variable length decoding on the third-type stream data recorded in the third recording area, so as to generate output data, the third-type variable length decoding being for decoding the third-type stream data into a data format applied before the third-type variable length coding is performed.

The coding/decoding apparatus may further include: a selection unit which selects one of the first-type variable length decoding unit and the third-type variable length decoding unit as a supplier of the output data; and a selection control unit which causes the selection unit to select the supplier based on a temporal relationship between a recording time and a reproduction time.

The selection control unit may cause the selection unit (a) to select the first-type variable length decoding unit as the supplier when reproduction processing is started during recording processing, and (b) to select the third-type variable length decoding unit as the supplier as the reproduction time approaches to the recording time.

Thus, by using a stream format that does not include a sequential process such as arithmetic coding/decoding instead of a final stream for a stream used in chasing playback, the amount of data exchange with a buffer can be reduced and a reproduction time can catch up with a recording time.

The second-type variable length coding unit may perform arithmetic coding as the sequential processing.

The structure as described above enables extraction of an intermediate stream and is stored in a high-capacity storage device such as a DVD and an HDD and omission of a sequential process such as arithmetic coding/decoding, even if a recording time and a reproduction time are slightly distant from each other. Therefore, it is possible to reduce the amount of data exchange with a buffer as well as to display a reproduction screen until the reproduction time catches up with the recording time,

The coding/decoding apparatus may further include: a first buffer memory unit which stores the first-type stream data generated by the first-type variable length coding unit; a selection unit which selects an output destination of the first-type stream data stored in the first buffer memory unit; and a selection control unit which controls the selection unit to select the output destination based on a temporal relationship between a recording time and a reproduction time.

In the case where the input data is generated from third-type stream data which does not require the sequential processing, the coding/decoding apparatus may further include: a third recording unit which records the third-type stream data into a third recording area; and a third-type stream data decoding unit which decodes the third-type stream data recorded in the third recording area, so as to generate output data.

With such a structure as described above, since an arithmetic coding process is not performed, it is possible to reduce the amount of stream transmission with an SDRAM, and a reproduction time can catch up with a recording time in chasing playback.

The coding/decoding apparatus may further include a second recording unit which records the first-type stream data stored in the first buffer memory unit into a second recording area, wherein the selection control unit may control the first buffer memory unit and the second recording unit so that the first-type stream data of a time which is closer to the recording time is preferentially retained.

The coding/decoding apparatus may further include a second recording unit which records the first-type stream data stored in the first buffer memory unit into a second recording unit, wherein said selection control unit may control the first buffer memory unit and the second recording unit so that the first-type stream data of a time which is closer to a pausing time is preferentially retained.

With such a structure as described above, it is possible to switch between the following two cases: in the case where a temporal distance between a reproduction time and a recording time are distant from each other, chasing playback using normal arithmetic coding/decoding is operated; and in the case where the temporal distance is closer chasing playback can be operated without arithmetic coding/decoding processing. Therefore, it is possible to partially reduce the amount of data exchange with a buffer while suppressing the capacity for storing intermediate streams into a high-capacity storage device to minimum, and also, a reproduction time can catch up with a recording time.

The coding/decoding apparatus may further include: a selection unit which selects a supplier of the first-type stream data inputted into the first-type variable length decoding unit; and a selection control unit which causes the selection unit to select the supplier based on a temporal relationship between a recording time and a reproduction time.

With such a structure as described above, it is possible to switch between the following two cases: in the case where a temporal distance between a reproduction time and a recording time are distant from each other, chasing playback using normal arithmetic coding/decoding is operated; and in the case where the temporal distance is close, chasing playback can be operated without arithmetic coding/decoding processing. Therefore, it is possible to partially reduce the amount of data exchange with a buffer while suppressing the capacity for storing intermediate streams into a high-capacity storage device to minimum, and also, a reproduction time can catch up with a recording time.

Note that the present invention can be realized not only as such a coding/decoding apparatus, but also as a method for controlling the coding/decoding apparatus, and even as a program which causes a computer system to execute the method. The present invention may also be realized as an integrated circuit to be implemented in the coding/decoding apparatus.

As described above, according to the coding/decoding apparatus of the present invention, even if a recording time and a reproduction time are slightly distant from each other, it is possible to extract an intermediate stream which is once stored in a high-capacity storage device such as a DVD and an HDD, and omit a sequential process such as arithmetic coding/decoding and the like. Therefore, it is possible to reduce the amount of data exchange with a buffer as well as to smoothly display a playback screen until the recording time catches up with the reproduction time.

Also, regarding the stream to be used in the chasing playback, by using a stream format which does not include sequential processing such as arithmetic coding/decoding, instead of a final stream, it is possible to reduce the amount of data exchange with a buffer as well as to allow a reproduction time to catch up with a recording time.

Further Information About Technical Background to this Application

The disclosure of Japanese Patent Application No. 2005-266095 filed on Sep. 13, 2005, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a configuration of a conventional coding/decoding apparatus (coding function);

FIG. 2 is a block diagram showing a configuration of the conventional coding/decoding apparatus (decoding function);

FIG. 3A is a time chart showing conventional coding/decoding processing;

FIG. 3B is a time chart showing conventional coding/decoding processing;

FIG. 4 is a block diagram showing a configuration of the coding/decoding apparatus according to a first embodiment of the present invention;

FIG. 5 is a block diagram showing a configuration of the coding/decoding apparatus according to the first embodiment;

FIG. 6 is a block diagram showing a configuration of the coding/decoding apparatus (coding function) according to the first embodiment;

FIG. 7 is a block diagram showing a configuration of the coding/decoding apparatus (decoding function) according to the first embodiment;

FIGS. 8A and 8B are pattern diagrams respectively showing a relationship between input and output of a stream;

FIG. 9 is a pattern diagram showing a management state of CPB;

FIG. 10 is a flowchart showing recording processing executed in the coding/decoding apparatus according to the first embodiment;

FIG. 11 is a flowchart showing reproduction processing executed in the coding/decoding apparatus according to the first embodiment;

FIG. 12 is a flowchart showing a chasing playback operation executed in the coding/decoding apparatus according to the first embodiment;

FIG. 13 is a block diagram showing a configuration of the coding/decoding apparatus according to a second embodiment of the present invention;

FIG. 14 is a flowchart showing a chasing playback operation executed in the coding/decoding apparatus according to the second embodiment;

FIG. 15 is a block diagram showing a configuration of the coding/decoding apparatus according to a third embodiment of the present invention;

FIG. 16 is a flowchart showing selection control processing executed by a selection control unit according to the third embodiment;

FIG. 17 is a state transition diagram for selecting an intermediate stream;

FIGS. 18A through 18H are pattern diagrams respectively showing a time relationship between a recording time and a reproduction time in chasing playback;

FIG. 19 is a block diagram showing a configuration of the coding/decoding apparatus according to a fourth embodiment of the present invention;

FIGS. 20A through 20D are pattern diagrams respectively showing a time relationship between a recording time and a reproduction time during a pause operation;

FIG. 21 is a block diagram showing an AV processing unit which realizes an H.264 recorder;

FIG. 22 is a block diagram showing a configuration of the coding/decoding apparatus according to another embodiment of the a present invention;

FIG. 23 is a block diagram showing a configuration of the coding/decoding apparatus according to another embodiment of the present invention; and

FIG. 24 is a block diagram showing a configuration of the coding/decoding apparatus according to another embodiment of the present invention.

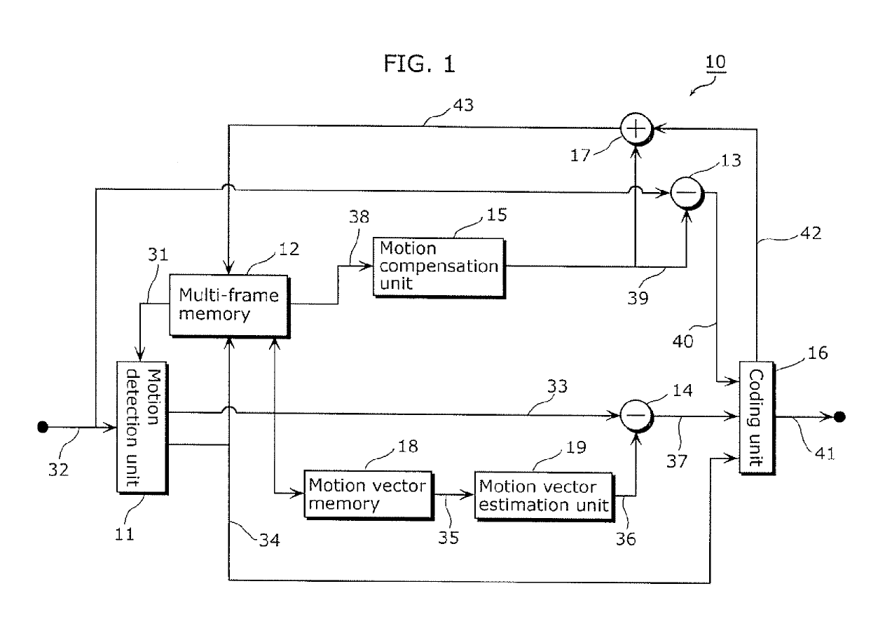

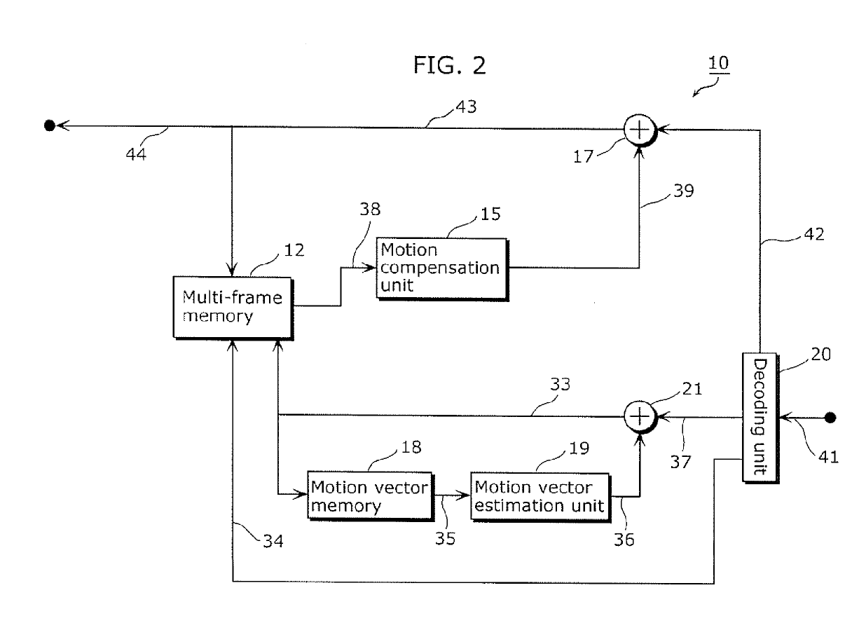

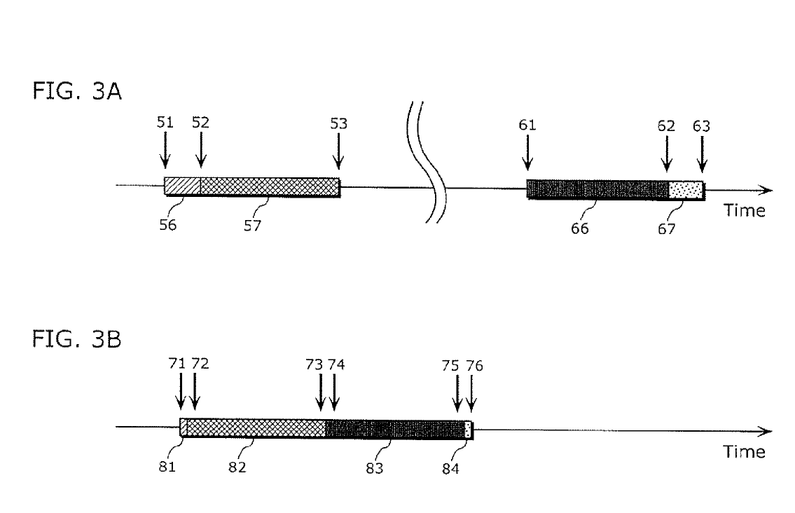

### DESCRIPTION OF THE PREFERRED EMBODIMENT(S)

(First Embodiment)

The following describes the first embodiment of the present invention with reference to the drawings.

The coding/decoding apparatus according to the present embodiment (a) performs coding and decoding at the same time, (b) performs first-type variable length coding that does not include arithmetic coding on input data, so as to generate first-type stream data, (c) performs second-type variable length coding that is different from the first-type variable length coding, on the first-type stream data, so as to generate second-type stream data, (d) records the second-type stream data into a first recording area, and (e) performs first-type variable length decoding for decoding a data format of the first-type stream data into a data format applied before the first-type variable length coding is performed, so as to generate output data.

To be more concrete, for chasing playback the program which is presently being recorded, the coding/decoding apparatus performs the first-type variable length coding on input syntax data so as to generate first-type stream data, stores the generated first-type stream data into a first buffer, performs second-type variable length coding (arithmetic coding) on the first-type stream data stored in the first buffer, so as to generate second-type stream data, and also performs the first-type variable length coding on the first-type stream data stored in the first buffer, so as to generate output syntax data.

The “input syntax data” is a syntax which includes a inter-picture prediction error, a motion vector predictive difference and a reference frame number which have not been inputted into the coding/decoding apparatus.

The “output syntax data” is a syntax which includes a motion vector predictive difference and a reference frame number which are to be outputted from the coding/decoding apparatus.

The “first-type stream data” is stream data generated by performing the first-type variable length coding on input syntax data, and is also an intermediate steam. Hereinafter, such a first-type stream data is also referred to as “intermediate stream”.

The “second-type stream data” is stream data generated by performing the second-type variable length coding on the first-type stream data, and is also a final stream data. Hereinafter, such a second-type stream data is also referred to as a final stream.

The “first-type variable length coding” is a coding process performed, in the variable length coding, without using arithmetic coding before the second-type variable length coding. Note that the processing of decoding the data coded through the first-type variable length coding is defined as “first-type variable length decoding”.

The “second-type variable length coding” is a coding process performed using arithmetic coding in the variable length coding. Note that the processing of decoding the data coded through the second-type variable length coding is defined as “second-type variable length decoding”.

Based on what is described above, the coding/decoding apparatus of the present embodiment will be described.

Firstly, the configuration of the coding/decoding apparatus of the present embodiment is described.

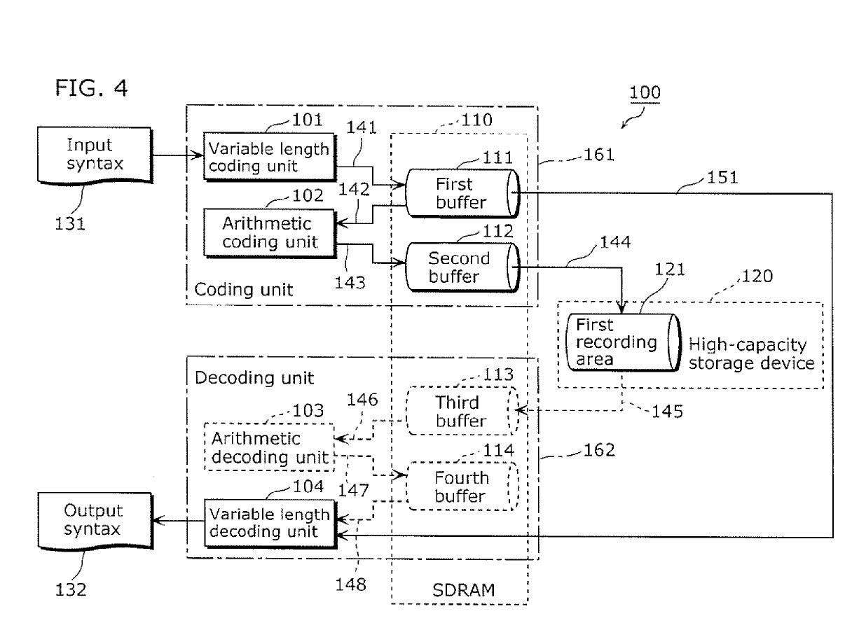

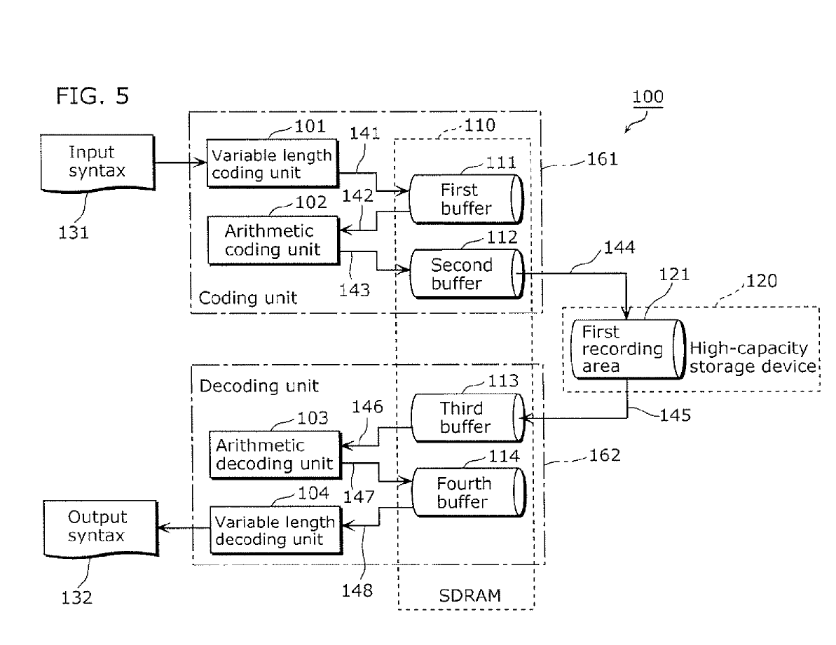

FIGS. 4 and 5 are block diagrams respectively showing a configuration of the picture coding/decoding apparatus according to the first embodiment of the present invention. As shown in FIG. 4, for operating chasing playback of a program that is presently being recorded, a coding/decoding apparatus 100 performs, via the variable length decoding unit 104, variable length decoding on an intermediate stream that is temporarily stored in the first buffer ill, so as to generate output syntax data, and outputs the generated output syntax data. On the other hand, as shown in FIG. 5, for operating normal replay of a recorded program, the coding/decoding apparatus 100 performs, via the variable length decoding unit 104, variable length decoding on an intermediate stream that is temporarily stored in the fourth buffer 114, so as to generate output syntax data, and outputs the generated output syntax data.

As shown in FIGS. 4 and 5, the coding/decoding apparatus 100 is configured of a variable length coding unit 101, an arithmetic coding unit 102, a variable length decoding unit 104, an arithmetic decoding unit 103, a first buffer 1117 a second buffer 112, a third buffer 113, a fourth buffer 114 and a first recording unit 121.

The variable length coding unit 101 performs variable length coding on input syntax data so as to generate an intermediate stream, and stores the generated intermediate stream into the first buffer 111. The arithmetic coding unit 102 performs arithmetic coding on the intermediate stream stored in the first buffer 111 so as to generate a final stream, and stores the generated final stream into the second buffer 112. The arithmetic decoding unit 103 by performs arithmetic decoding on the final stream stored into the third buffer 113, so as to generate an intermediate stream, and stores the generated intermediate stream into the fourth buffer 114.

For operating chasing playback of a program that is presently being recorded, the variable length decoding unit 104 performs variable length decoding on the intermediate stream stored in the first buffer 111 instead of the fourth buffer 114, so as to generate output syntax data, and outputs the generated output syntax data (see FIG. 4). On the other hand, for operating normal replay on a recorded program, the variable length decoding unit 104 performs variable length decoding on the intermediate stream stored in the fourth buffer 114, so as to generate output syntax data, and outputs the generated output syntax data (see FIG. 5)

In the first buffer 111, the intermediate stream generated by the variable length coding unit 101 is temporarily stored. In the second buffer 112, the final stream generated by the arithmetic coding unit 102 is temporarily stored. In the third buffer 113, the final stream stored in the first recording unit 121 is temporarily stored. In the fourth buffer 114, the intermediate stream generated by the arithmetic decoding unit 103 is temporarily stored.

During the recording of the program, the first recording unit 121 accumulates the final stream stored in the second buffer 112. During the replay of the program, the first recording unit 121 stores the accumulated final stream into the third buffer 113 Note that during the chasing playback of the program, the first recording unit 121 accumulates the final stream stored in the second buffer 112, but does not store the accumulated final stream into the third buffer 113.

The first buffer 111, the second buffer 112, the third buffer 113, and the fourth buffer 114 are assigned to plural SDRAMs 110 or one common SDRAM 110.

A high-capacity storage device 120 is a device such as a DVD drive and a hard disk drive, and stores digital data into a random-accessible storage medium such as a DVD and a hard disk.

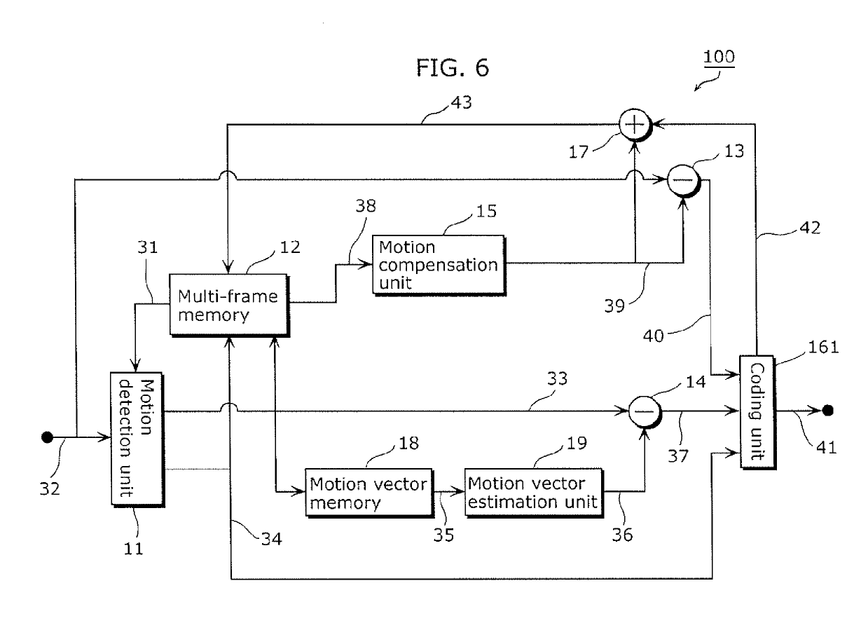

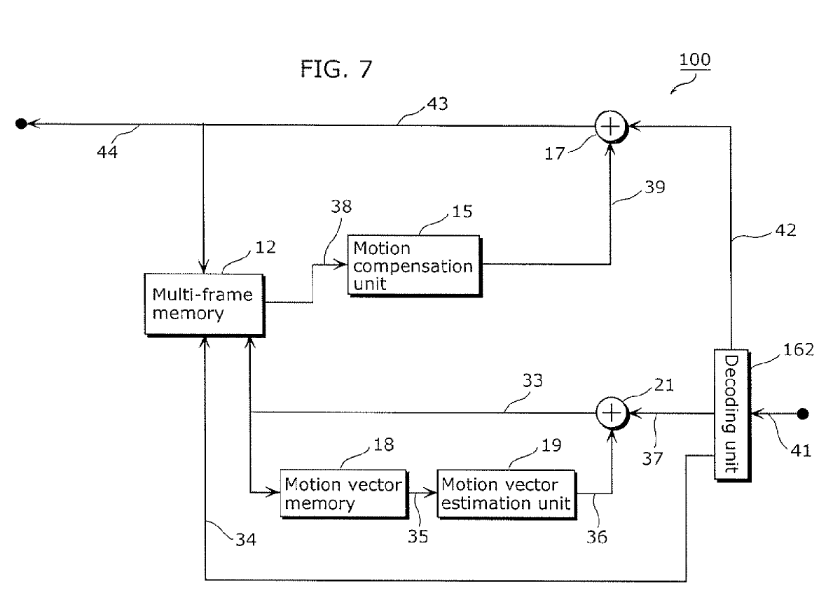

A coding unit 161 in the coding/decoding apparatus (coding function) 100 shown in FIG. 6 is configured of the variable length coding unit 1011 the arithmetic coding unit 102, the first buffer 111, and the second buffer 112. The coding/decoding apparatus (decoding function) 100 shown in FIG. 7 is configured of a decoding unit 162, the arithmetic decoding unit 103, the variable length decoding unit 104, the third buffer 113 and the fourth buffer 114.

A syntax which includes the inter-picture prediction error 40, the motion vector predictive difference 37, the reference frame number 34 which are shown in FIG. 6, is inputted into the variable length coding unit 101.

The syntax which includes the motion vector predictive difference 37 and the reference frame number 34 which are shown in FIG. 7, is outputted as output syntax data from the variable length decoding unit 104

The final stream (coded signal 41 in FIG. 6) outputted from the arithmetic coding unit 102 and the final stream (coded signal 41 in FIG. 7) inputted into the arithmetic decoding unit 103 have the same stream format.

The intermediate stream outputted from the variable length coding unit 101, the intermediate stream inputted into the arithmetic coding unit 102, the intermediate stream outputted from the arithmetic decoding unit 103 and the intermediate stream inputted from the variable length decoding unit 104 all have the same stream format.

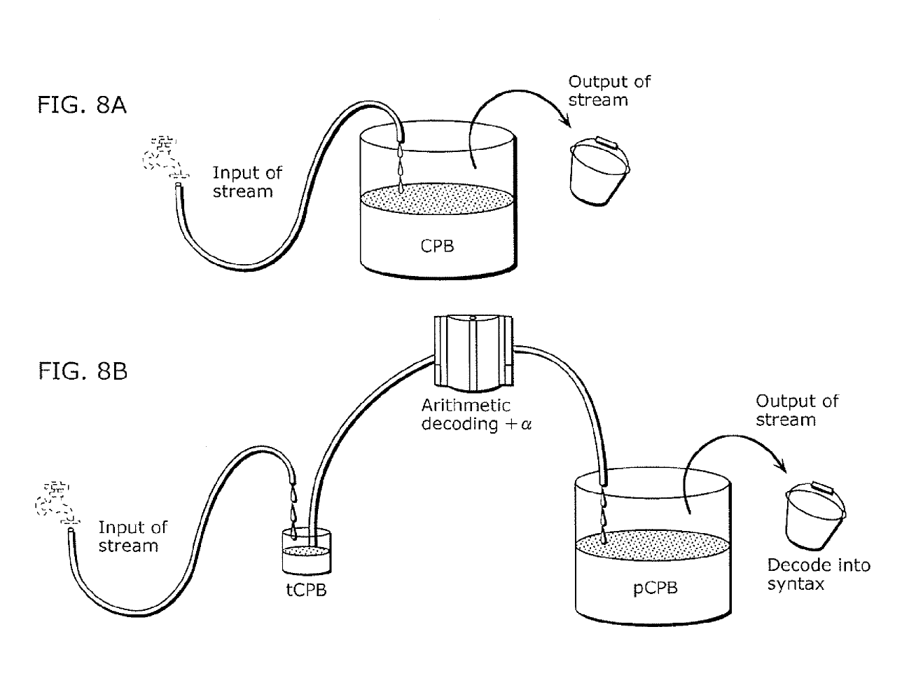

Note that the third buffer 113 and the fourth buffer 114 are equivalent to the buffers (tCPB) and (pCPB) shown in FIG. 8B. The buffer (tCPB) is a buffer for temporarily storing an input stream, whereas the buffer (pCPB) presents a CPB (Coded Picture Buffer) into which a stream obtained after the previous step of decoding which includes arithmetic coding. Thus, as shown in FIG. 8B, in the arithmetic decoding which includes a CPB, the problem in the arithmetic decoding that requires sequential processing can be absorbed by storing input stream into the buffer (pCPB) while constantly performing arithmetic decoding on the input stream.

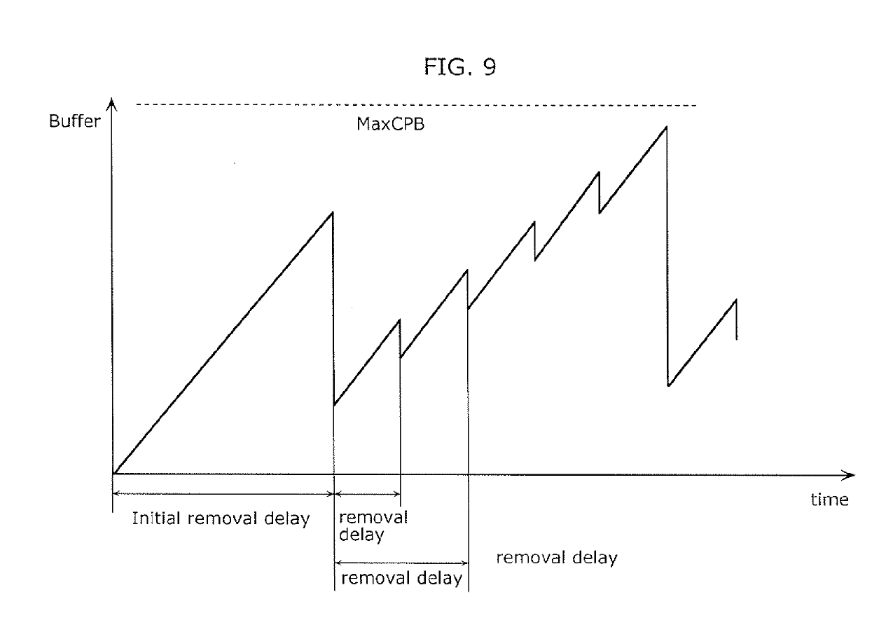

This is because a stream is constantly inputted into the CPB, whereas a stream is instantaneously outputted, as shown in FIG. 8A. That is to say, in the case where a stream is inputted, the stream is inputted constantly; therefore, a buffer capacity steadily increases, and in the case where a stream is outputted, the amount of stream accumulated in the buffer drops vertically because the stream is outputted instantaneously, as shown in FIG. 9.

Note that the concept described above also applies to variable length coding.

Here, due to the separate configuration of the variable length decoding unit 104 and the arithmetic decoding unit 103 that is operated with performance of constant rate, decoding is similar to processing a picture input stream in a virtual buffer.

In FIG. 9, a horizontal axis presents a time direction while a vertical axis presents a buffer capacity, and MaxCPB denotes a value indicative of an upper limit of a CPB, the buffer is virtually controlled so as not to exceed this value.

As shown in FIG. 9, assuming that a stream stored on a picture basis is taken out altogether after the storage of an input stream into the CPB, the stream is coded in such a manner that a capacitance value of the CPB is not exceeded.

Subsequently, the operation of the coding/decoding apparatus 100 according to the present embodiment will be described.

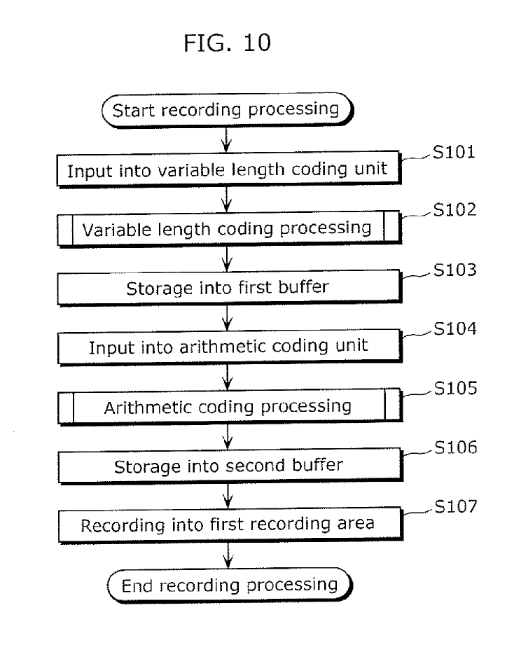

As shown in FIG. 10, for the recording operation, a current syntax to be variable length coded which includes the inter-picture prediction error 40, the motion vector predictive difference 37 and the reference frame number 34 is inputted as input syntax data 131 into the variable length coding unit 101 (S101). The variable length coding unit 101 performs variable length coding on the input syntax data 131 so as to generate an intermediate stream 141 (S102). The intermediate stream 141 generated by the variable length coding unit 101 is temporarily stored into the first buffer 111 (S103), and then inputted into the arithmetic coding unit 102 (S104), The arithmetic coding unit 102 performs arithmetic coding on the intermediate stream 142 inputted from the first buffer, so as to generate a final stream 143 (S105). The final stream generated by the arithmetic coding unit 102 is temporarily stored into the second buffer 112 (S106), and then recorded into the first recoding area 121 in the high-capacity storage device 120 (S107).

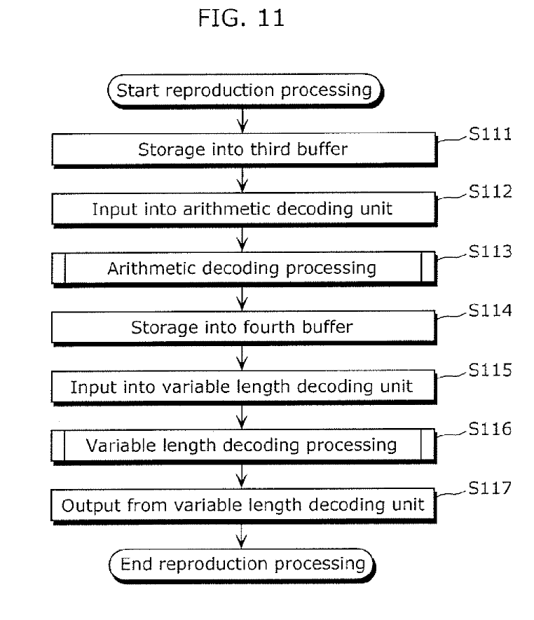

As shown in FIG. 11, for the reproduction processing, the final stream 145 recorded in the first recording area 121 of the high-capacity storage device 120 is temporarily stored in the third buffer 113 (S111), and then inputted into the arithmetic decoding unit 103 (S112). The arithmetic decoding unit 103 performs arithmetic decoding on a final stream 146 inputted from the third buffer 113, so as to generate an intermediate stream 147 (S113). The intermediate stream 147 generated by the arithmetic decoding unit 103 is temporarily stored into the fourth buffer 114 (S114), and then inputted into the variable length decoding unit 104 (S115). The variable length decoding unit 104 performs variable length decoding on the intermediate stream 148 inputted from the fourth buffer 114, so as to generate output syntax data 132 (S116). Then, the output syntax data 132 generated by the variable length decoding unit 104 is outputted (S117).

It is considered that, by simply replaying a program while recording the program, chasing playback can be realized. However, the generation of the output syntax 132 by performing variable length decoding on the intermediate stream 148 stored in the fourth buffer 114, as shown in FIG. 4, may cause the case where the reproduction cannot catch up with the recording due to the arithmetic coding and arithmetic decoding which are sequentially performed. In contrast, the generation of the output syntax data 132 by performing variable length decoding on the intermediate stream 151 stored in the first buffer 111, as shown in FIG. 4, can solve such a problem.

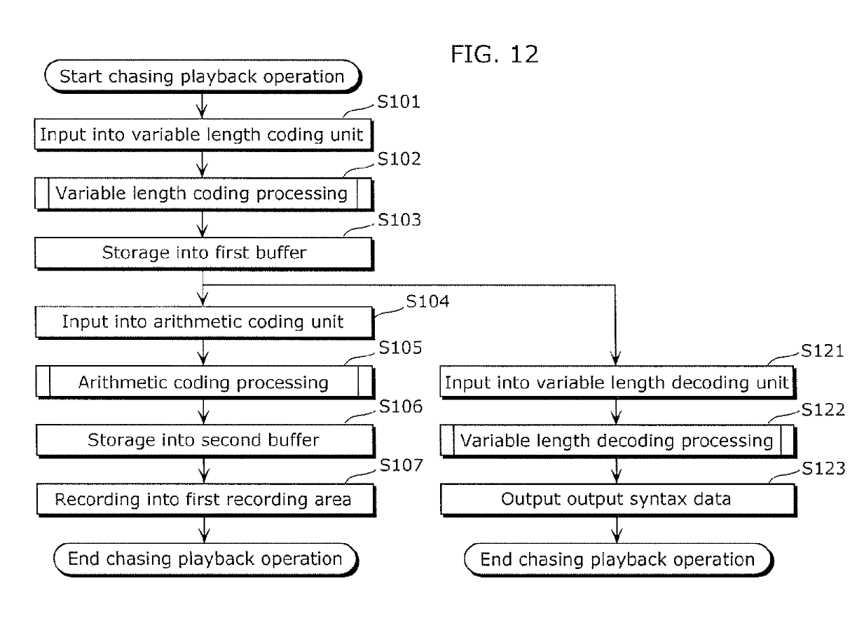

As shown in FIG. 12, for operating chasing playback, the intermediate stream 141 outputted from the variable length coding unit 101 is temporarily stored into the first buffer 111 (S103), and then also inputted into the variable length decoding unit 104 (S121). The variable length decoding unit 104 performs variable length decoding on the intermediate stream 151 inputted from the first buffer 111, so as to generate output syntax data 132 (S122), and outputs the generated output syntax data 132 (S123).

With regard to the recording processing, namely, coding of moving pictures, the input syntax data 131 is recorded as a final stream 144 into the first recording area 121 of the high-capacity storage device 120 through the same passage as used when the recording is performed. However, due to chasing playback, the management amount of the first buffer 111 is increased so that the stream is controlled.

For operating chasing playback, the intermediate stream 151 outputted from the first buffer 111, instead of the intermediate stream 148 outputted via the third buffer 113, the arithmetic decoding unit 103 and the fourth buffer 114, is inputted into the variable length decoding unit 104. The intermediate stream 151 outputted from the first buffer 111 has the same stream format as the intermediate stream 148 outputted from the fourth buffer 114; therefore, variable length decoding is performed by the variable length decoding unit 104 without any problems so that the output syntax data 132 is generated and then outputted. In other words, since only variable length decoding without arithmetic decoding is enough to realize replay processing, it is possible to decrease the amount of memory access to SDRAM as well as to allow a reproduction time to catch up with a recording time.

Note that by managing the management amount of the first buffer 111 by a First-In First-Out (FIFO) method in which the management amount is greater than the case of normal recording and by increasing a storage (accumulation) amount of intermediate stream, an intermediate stream is made available even in the case where a reproduction time and a recording time are distant from each other.

Here, the coding/decoding apparatus 100 is configured to execute a former step of decoding arithmetic codes and other transformation, and a latter step of temporarily storing the result of the former step and the remaining process of performing transformation in variable length decoding.

Note that buffering is performed on arithmetic-decoded binary data. In this case, sequential processing on a bit basis is necessary. For re-transforming the buffered binary data into multiple-value data, it is possible to perform processing on a syntax basis.

(Second Embodiment)

Next, the second embodiment of the present invention will be described with reference to the drawings.

For replaying a program that is presently being recorded, the coding/decoding apparatus according to the present embodiment performs first-type variable length coding on input syntax data so as to generate first-type stream data, stores the generated first-type stream data in the first buffer, as well as performs second-type variable length coding on the first-type stream data stored in the first buffer, so as to generate second-type stream data, stores the generated second-type stream data into a second buffer, and accumulates the second-type stream data stored in the second buffer into a first recording area. During this process, the coding/decoding apparatus also accumulates the first-type stream data stored in the first buffer into a second recording area, stores the first-type stream data accumulated into the second recording area into a fifth buffer, and performs the first-type variable length decoding on the first-type stream data stored in the fifth buffer, so as to generate output syntax data.

Based on what is described above, the coding/decoding apparatus of the present embodiment will be described. Note that the same referential codes are assigned to the same components as those of the coding/decoding apparatus according to the first embodiment, and the descriptions are omitted.

Firstly, the configuration of the coding/decoding apparatus according to the present embodiment is described.

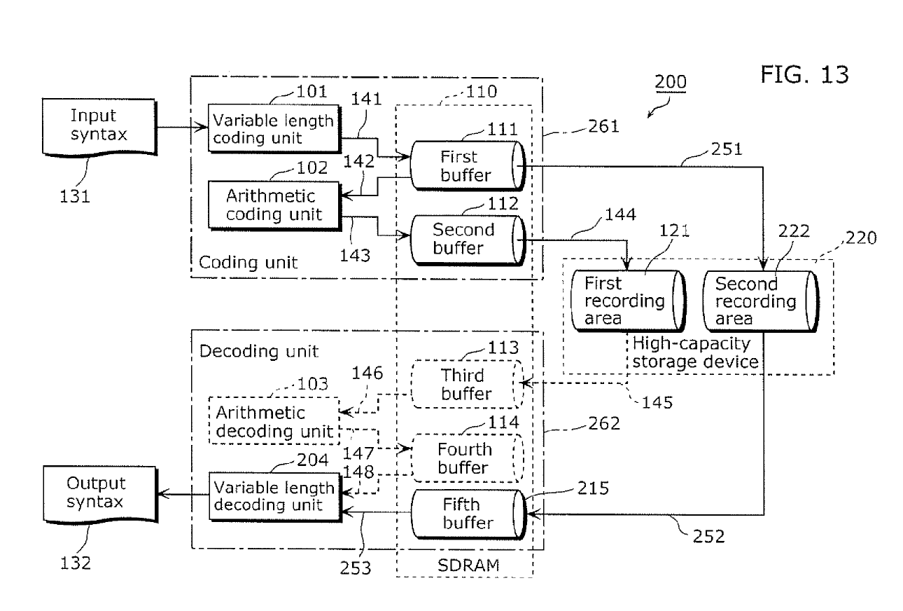

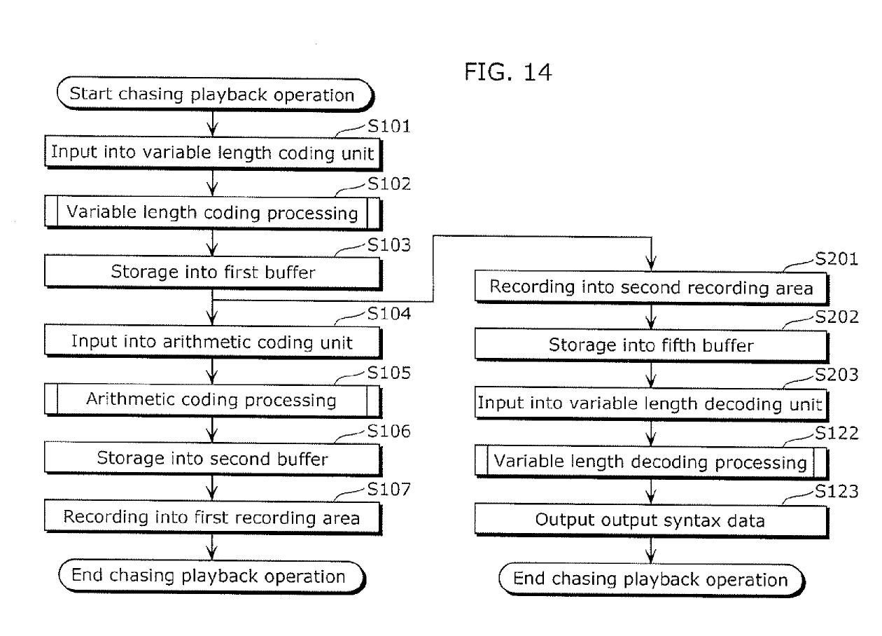

FIG. 13 is a block diagram showing the configuration of the coding/decoding apparatus according to the present embodiment. As shown in FIG. 13, a coding/decoding apparatus 200 further includes a variable length decoding unit 204, a fifth buffer 215 and a second recording area 222, as compared with the coding/decoding apparatus 100 (see FIG. 4) of the first embodiment.

Note that the third buffer 113, the fourth buffer 114 and the arithmetic decoding unit 103, which are not used in the case of chasing playback in the present embodiment, are indicated by a dashed line.

The intermediate stream 253 outputted from the fifth buffer 215, instead of the intermediate stream 148, is inputted into the variable length decoding unit 204.

The fifth buffer 215 stores the intermediate stream 252 outputted from the second recording area 222.

The second recording area 222 is a recording area assigned to the high-capacity storage device 220, and records the intermediate stream 251 outputted from the first buffer 111.

The following describes the operation of the coding/decoding apparatus 200 of the present embodiment.

Note that, regarding the recording processing, namely, coding of moving pictures, the input syntax 131 is recorded as a final stream 144 into the first recording area 121 of the high-capacity storage device 220 through the same passage as mentioned in the description of FIG. 5. When chasing playback is started, the final stream 144 is recorded into the first recording area 121, and at the same time, the intermediate stream 251 outputted from the first buffer 111 is recorded into the second recording area 222.

In other words, in the case of chasing playback, instead of the intermediate stream 148 outputted from the fourth buffer 114, the intermediate stream 252 outputted from the second recording area 222 of the high-capacity storage device 220 is inputted into the fifth buffer 215. Once the intermediate stream 252 is stored into the fifth buffer 215, the intermediate stream 253 outputted from the fifth buffer 215 is inputted into the variable length decoding unit 204. The intermediate stream 253 outputted from the fifth buffer 215 has the same stream format as the intermediate stream 148 outputted from the fourth buffer 114. Therefore, transformation can be performed by the variable length decoding unit 204 without any problems. Then, the output syntax 132 is outputted from the variable length decoding unit 204.

In this case, in the case of chasing playback, the intermediate stream 141 outputted from the variable length coding unit 101 is temporarily stored into the first buffer 111 (S103), and then recorded into the second recording area 222 (S201). Moreover, the intermediate stream 252 outputted from the second recording area 222 is temporarily stored into the fifth buffer 215 (S202), and then inputted into the variable length decoding unit 204 (S203). The variable length decoding unit 204 performs variable length decoding on the intermediate stream 252 inputted from the fifth buffer 215, so as to generate output syntax data (S122), and outputs the generated output syntax data (S123),

As described above, with the coding/decoding apparatus 200 of the present embodiment, a replay process is allowed only by variable length decoding process which does not include arithmetic decoding. It is therefore possible to decrease the amount of memory access to the SDRAM as well as to allow a reproduction time to catch up with a recording time. In the case of using the intermediate stream 251 outputted from the first buffer 111 of the first embodiment, it is conceivable to limit the capacity in order to place the first buffer 111 on the SDRAM. However, in the present embodiment, an intermediate stream is temporarily stored into the high-capacity storage device 220 such as a DVD, a hard disk and d memory card and the temporarily-stored intermediate stream is used; therefore, even the case where a recording time and a reproduction time are distant from each other can be handled.

Note that the second recording area 222 needs to use an area which is not used as the first recording area 121 within the high-capacity storage device 220. Therefore, through the management based on the FIFO method, control is performed so that an area equivalent to a tenth of the high-capacity storage device 220 is efficiently utilized, for example.

(Third Embodiment)

The following describes the third embodiment of the present invention with reference to the drawings.

For operating chasing playback of a program that is presently being recorded, the coding/decoding apparatus according to the present embodiment performs first-type variable length coding on input syntax data so as to generate first-type stream data, stores the generated first-type stream data into the first buffer as well as performs second-type variable length coding on the first-type stream data stored in a first buffer, so as to generate second-type stream data, stores the generated second-type stream data into a second buffer, and accumulates the second-type stream data stored in the second buffer into a first recording area. During this process, the coding/decoding apparatus also accumulates the first-type stream data stored in the first buffer into a second recording area, stores the first-type stream data accumulated in the second recording area into a fifth buffer, stores the second-type stream data accumulated in the first buffer into a third buffer, performs second-type variable length decoding on the second-type stream data stored in the third buffer, so as to generate first-type stream data, stores the generated first-type stream data into a fourth buffer, and performs first-type variable length decoding on the first-type stream data stored in one of the first, fourth and fifth buffers, so as to generate output syntax data.

Based on what is described above, the coding/decoding apparatus of the present embodiment will be described. Note that the same referential codes are assigned to the same components as those of the coding/decoding apparatus according to the first embodiment, and the descriptions are omitted.

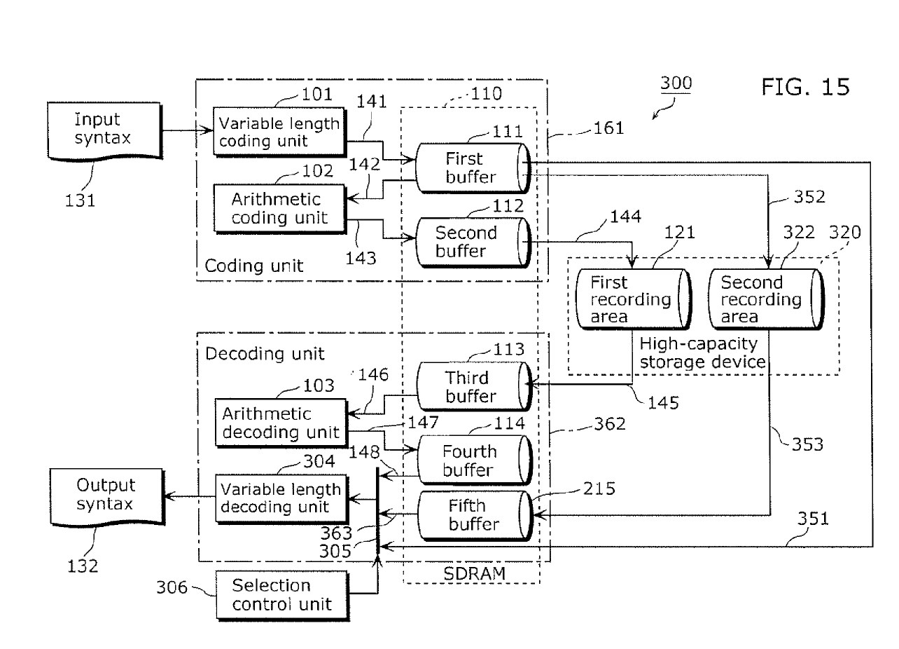

FIG. 15 is a block diagram showing the configuration of the coding/decoding apparatus according to the third embodiment. As shown in FIG. 15, a coding/decoding apparatus 300 includes a variable length decoding unit 304 instead of the variable length 25 decoding unit 104. Moreover, the coding/decoding apparatus 300 further includes a selection unit 305, a selection control unit 306, a fifth buffer 315 and a second recording area 322.

The intermediate stream selected by the selection unit 305, instead of a direct input of the intermediate stream 148, is inputted into the variable length decoding unit 304.

The selection unit 305 selects an intermediate stream to be inputted into the variable length decoding unit 304 from among the intermediate stream 351 outputted from the first buffer 111, the intermediate stream 363 outputted from the fifth buffer 315 and the intermediate stream 148 outputted from the fourth buffer 114,

The selection control unit 306 outputs a control signal to the selection unit 305.

The fifth buffer 315 stores the intermediate stream 353 outputted from the second recording area 322.

The second recording area 322 records the intermediate stream 352 outputted from the first buffer 111.

Subsequently, the operation of the coding/decoding apparatus 300 of the present embodiment will be described.

The following describes a flow of a signal according to the third embodiment.

With regard to recording processing, that is, coding of moving is pictures, the same passage as used in the description of FIG. 5 is used, and the input syntax 131 is recorded as the final stream 144 into the first recording area 121 of a high-capacity storage device 320. In contrast, when chasing playback starts, the management amount of the first buffer 111 is increased, and the final stream 144 is recorded into the first recording area 121. At the same time, the intermediate stream 352 outputted from the first buffer 111 is recorded into the second recording area 322.

On the other hand, in the chasing playback operation, the selection unit 305 selects one of the intermediate stream 148 outputted from the fourth buffer 114, the intermediate stream 363 outputted from the fifth buffer 315 and the intermediate stream 351 outputted from the first buffer 111, and the selected intermediate stream is inputted into the variable length decoding unit 304. Then, the output syntax 132 is outputted from the variable length decoding unit 304. Here, the selected intermediate stream has the same stream format as the intermediate stream outputted from the fourth buffer 114; therefore, the variable length decoding unit 304 can perform variable length decoding without any problems.

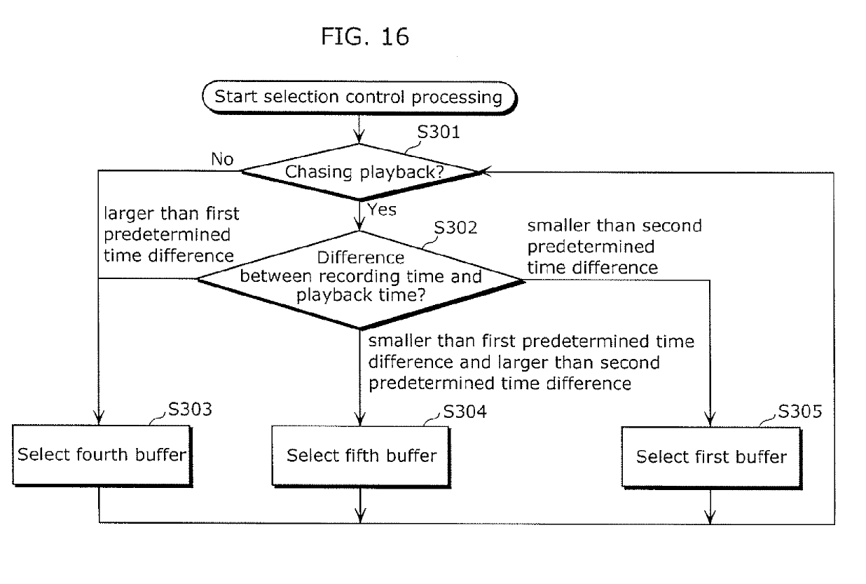

As shown in FIG. 16, when chasing playback starts (Yes in S301) and in the case where a difference between a recording time and a reproduction time is larger than a first predetermined time difference (larger than first predetermined time difference in S302), the selection control unit 306 outputs, to the selection unit 305, a control signal for allowing the selection of the fourth buffer 114 as a supplier (S303). in the case where the difference is smaller than the first predetermined time difference and larger than a second predetermined time difference (smaller than first predetermined time difference and larger than second predetermined time difference in S302), the selection control unit 306 outputs, to the selection unit 305, a control signal for allowing the selection of the fifth butter 315 as a supplier (S304). In the case where the difference is smaller than the second predetermined time difference (smaller than second predetermined time difference in S302), the selection control unit 306 outputs, to the selection unit 305, a control signal for allowing the selection of the first buffer 111 as a supplier (S305).

Here, the control performed by the selection control unit 306 for selecting an intermediate stream is described.

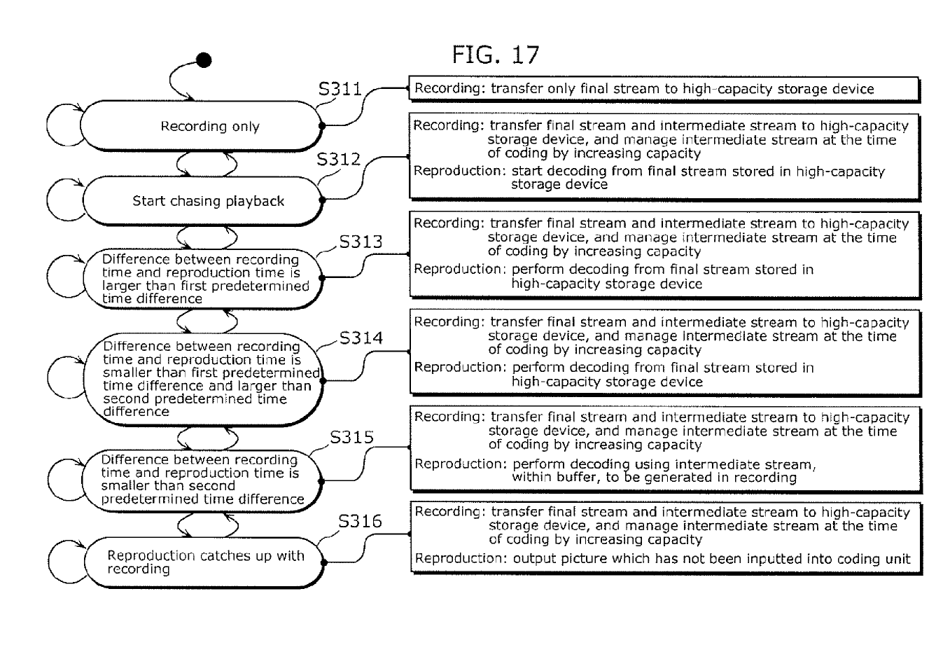

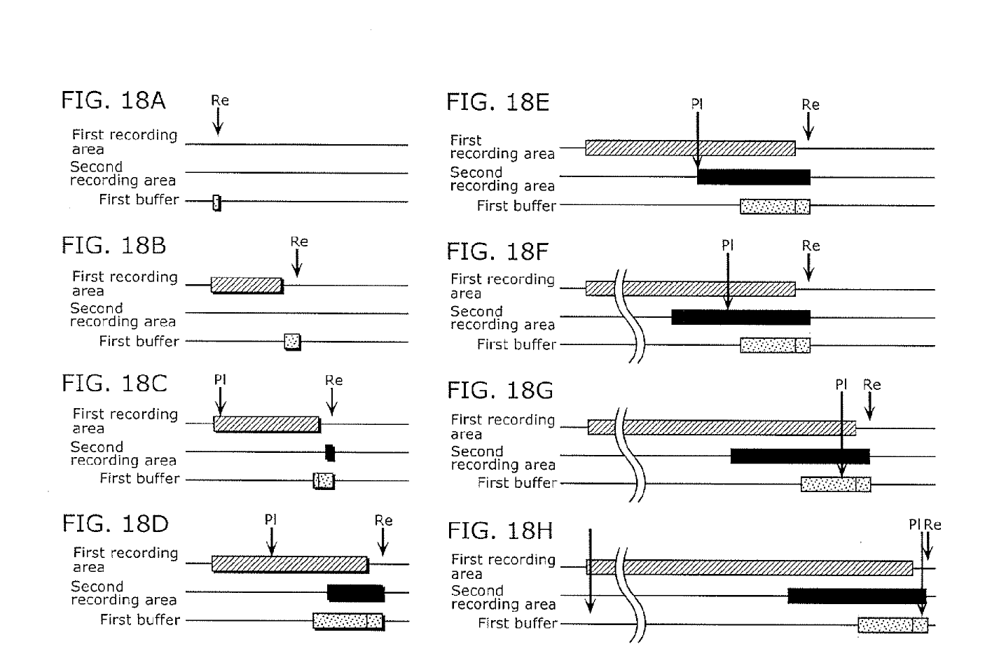

FIG. 17 is a state transition diagram for selecting an intermediate stream. FIGS. 18A through 18H are pattern diagrams indicating a temporal status of a recording area and a playback area in the operation of the chasing playback.

In FIGS. 18A through 18H, Re denotes a position for recording a stream, Pl presents a position for playing back the stream, while horizontal lines represent the respective streams held in the first recording area 121, the second recording area 322 and the first buffer 111, and three types of bars, hatched, black and dotted, indicate a temporal position of the stream.

As shown in FIG. 17, the selection control unit 306 controls the selection unit 305 according to the following states (S311) to (S316).

(S311): in the state of “Recording only”, the coding/decoding apparatus 300 transfers, for recording, only a final stream to the high-capacity storage device 320.

(S312): in the state of “Start chasing playback”, the coding/decoding apparatus 300 transfers, for recording, a final stream and an intermediate stream to the high-capacity storage device 320, increases the capacity of the first buffer 111, and manages the intermediate stream at the time of coding. The coding/decoding apparatus 300 starts decoding, for recording, from the final stream recorded in the high-capacity storage device 320. Here, the selection control unit 306 allows the selection unit 305 to select the fourth buffer 114 as a supplier.

(S313): in the state of “Difference between recording time and reproduction time is larger than first predetermined time difference”, the coding/decoding apparatus 300 transfers, for recording, a final stream and an intermediate stream to the high-capacity storage device 320, increases the capacity of the first buffer 111, and manages the intermediate stream at the time of coding. The coding/decoding apparatus 300 starts decoding, for reproduction, from the final stream recorded in the high-capacity storage device 320. Here, the selection control unit 306 allows the selection unit 305 to select the fourth buffer 114 as a supplier.

(S314): in the state of “Difference between recording time and reproduction time is smaller than first predetermined time difference and larger than second predetermined time difference”, the coding/decoding apparatus 300 transfers, for recording, a final stream and an intermediate stream to the high-capacity storage device 320, increases the capacity of the first buffer 111, and manages the intermediate stream at the time of coding. The coding/decoding apparatus 300 starts decoding, for reproduction, from the intermediate stream recorded in the high-capacity storage device 320. Here, the selection control unit 306 allows the selection unit 305 to select the fifth buffer 315 as a supplier.

(S315): in the state of “Difference between recording time and reproduction time is smaller than second predetermined time difference” the coding/decoding apparatus 300 transfers, for recording, a final stream and an intermediate stream to the high-capacity storage device 320, increases the capacity of the first buffer 111, and manages the intermediate stream at the time of coding. The coding/decoding apparatus 300 performs decoding, for reproduction, utilizing, for this purpose, the intermediate stream within the first buffer 111 in which the intermediate stream generated in the recording processing is temporarily stored. Here, the selection control unit 306 allows the selection unit 305 to select the first buffer 111 as a supplier.

(S316): in the state of “Playback catches up with recording”, the coding/decoding apparatus 300 transfers, for recording, a final stream and an intermediate stream to the high-capacity storage device 320, increases the capacity of the first buffer 111, and manages the intermediate stream at the time of coding, The coding/decoding apparatus 300 outputs, for reproduction, an input picture or a picture which has not been inputted into the coding unit.

In this case, when recording starts (S311), the coding/decoding apparatus 300 stores an intermediate stream into the first buffer 111, as shown in FIG. 18A. After that, the process proceeds to variable length coding and the coding/decoding apparatus 300 records the final stream 144 into the first recording area 121 of the high-capacity storage device 320, as shown in FIG. 18B. Here, the capacity of the first buffer 111 is managed to be minimum.

Then, when chasing playback starts (S312), the coding/decoding apparatus 300 records the final stream 144 into the first recording area 121 as well as records the intermediate stream 352 into the second recording area 322, as shown in FIG. 18C. Here, the capacity of the first buffer 111 is managed by expanding the accumulation amount thereof.

Moreover, in the case where the difference between a recording time and a reproduction time is larger than the first predetermined time difference, that is, the times are distant from each other (S313), the coding/decoding apparatus 300 records the final stream 144 into the first recording area 121 as well as records the intermediate stream 352 into the second recording area 322, as shown in FIG. 18D. However, since the amount of the intermediate stream 352 recorded into the second recording area 322 is not sufficient, the final stream 144 recorded in the first recording area 121 is used for chasing playback operation. Here, in the case where arithmetic decoding is a bottle neck for operating playback at a relatively high speed as 1 to 1.5 times as high as the normal speed, B pictures shall not be decoded.

In the case where the difference between a recording time and a reproduction time is smaller than the first predetermined time difference and larger than the second predetermined time difference, that is, the reproduction time is approaching the recording time (S314), as shown in FIG. 18E, since the sufficient amount of the intermediate stream 352 is recorded into the second recording area 322, an intermediate stream recorded in the second recording area 322 is used for chasing playback operation. Hereinafter, the operation of the arithmetic decoding unit 103 is not required, therefore, exchange of the stream data with the SDRAM becomes less. Note that the extendable capacity of the first buffer 111 is much limited compared to the second recording area 322; therefore, the intermediate stream stored in the first buffer 111 is managed by the FIFO method within a time shorter than the time required for the second recording area 322.

When a reproduction time gets slightly closer to a recording time as shown in FIG. 18F, the coding/decoding apparatus 300 uses the intermediate stream recorded in the second recording area 322. In this case, restriction is imposed greatly on the second recording area 322 more than the first recording area 121; therefore, the second recording area 322 is managed based on the FIFO method as is the case of the first buffer 111. Note that, for using the intermediate stream recorded in the second recording area 322, it is possible to perform reproduction processing even for B pictures since arithmetic coding is not necessary even in the reproduction operation at a relatively high speed.

Moreover, in the case where the difference between a recording time and a reproduction time is smaller than the second predetermined time difference, that is, the reproduction time is further approaching the recording time (S315), as shown in FIG. 18G, the coding/decoding apparatus 300 uses, for chasing playback operation, the intermediate stream stored in the first buffer 111.

In the case where a recording time and a reproduction time are almost the same, as shown in FIG. 18H, the coding/decoding apparatus 300 uses the intermediate stream stored in the first buffer 111. In this case, since there is no need to use an intermediate stream that passes through the high-capacity storage device 320, it is possible to smoothly perform the reproduction processing at a higher speed,

In the case where a reproduction time eventually catches up with a recording time (S316), the coding/decoding apparatus 300 reproduces using the pictures that have not been inputted into the coding unit 161 and that are to be generated in the process of coding an input picture or a picture. Thus, it is possible to perform control so that variable length decoding itself is not carried out separately.

As described above, the coding/decoding apparatus 300 of the present embodiment can perform reproduction processing only with the decoding process which does not include arithmetic coding, when not performing reproduction processing by normal variable length decoding operation. It is therefore possible to decrease an amount of memory access to the SDRAM as well as to allow a reproduction time to catch up with a recording time.

Through the selection of an intermediate stream as described above, it is possible to reduce, to a minimum level, the amount of unnecessary transmission of intermediate stream to and from the SDRAM, as well as to allow a reproduction time to catch up with a recording time in the chasing playback operation.

(Fourth Embodiment)

Next, the fourth embodiment of the present invention will be described with reference to the drawings.

Firstly, the configuration of the coding/decoding apparatus according to the present embodiment is described.

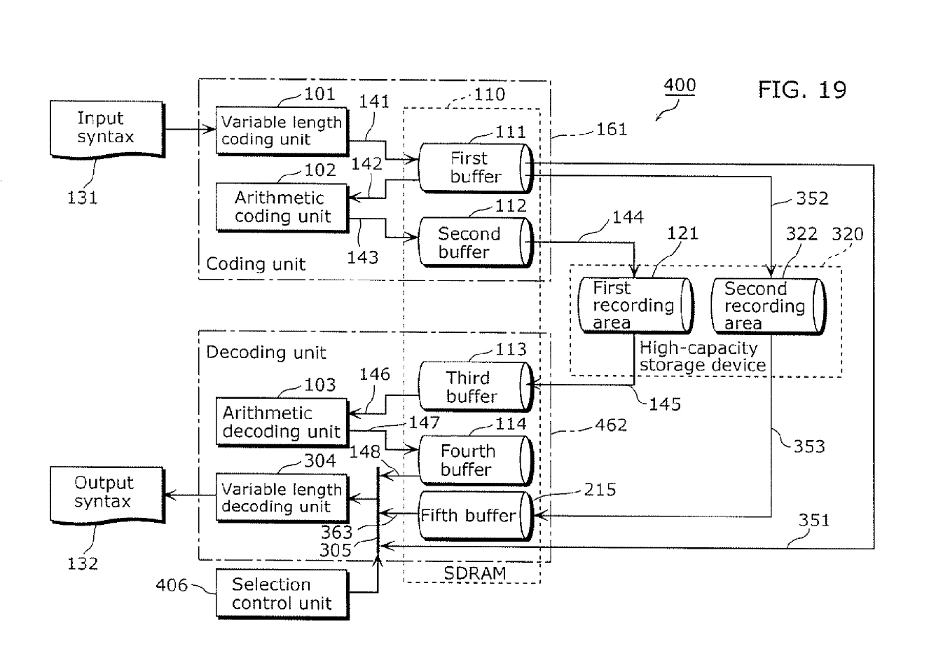

FIG. 19 is a block diagram showing the configuration of the coding/decoding apparatus of the present embodiment. As shown in FIG. 19, a coding/decoding apparatus 400 includes a selection control unit 406 instead of the selection control unit 306, which is a difference compared with the coding/decoding apparatus 300 of the third embodiment.

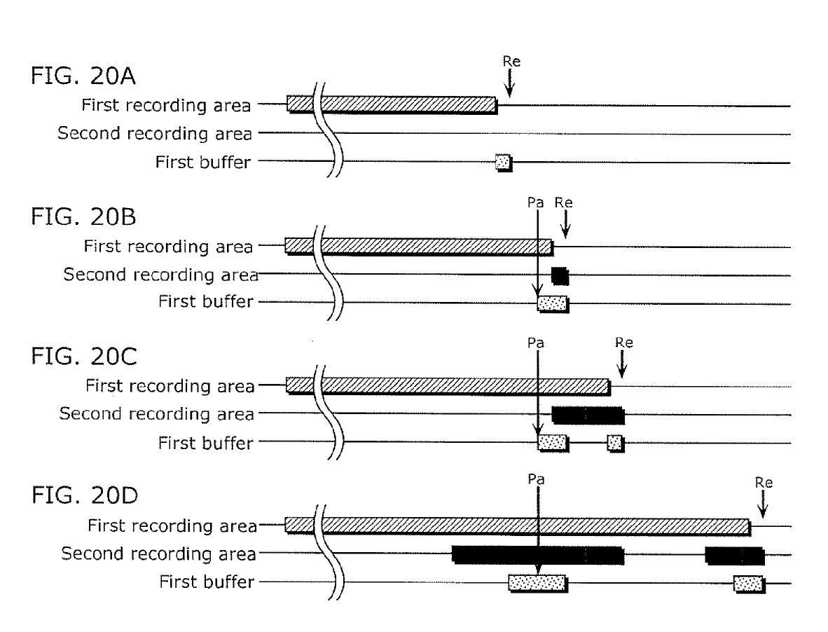

FIGS. 20A through 20D are pattern diagrams respectively showing temporal states of a recording area and a reproduction area in pausing operation. FIG. 20A shows a normal recording state, FIG. 20B shows a state in which a stream is accumulated immediately after the pausing is operated, FIG. 20C shows a state in which a stream is accumulated after little time has elapsed since the state-shown in FIG. 20B, FIG. 20D shows a state in which a stream is accumulated after quite a lot of time has elapsed since the pausing is operated. As is the case of FIG. 18, Re denotes a position for recording an accumulated stream, while three horizontal lines show a state of recording a stream in the first recording area 121, the second recording area 322 and the first buffer 111, respectively. The temporal position of the accumulated stream is shown by use of three types of bars, hatched, black and dotted. Pa shows a pausing time.

Firstly, in a normal recording state as shown in FIG. 20A, the final stream 144 is recorded into the first recording area 121. In this case, the first buffer 111 is controlled by the FIFO method with a minimum capacity required for recording. Here, the user using a recorder is assumed to view the pictures which have not been inputted into the coding unit 161. In the case where the user has to stop the scene he/she is viewing for some minutes because he/has something to do and continues viewing, the pausing is instructed. However, recording continues even after the pausing.

In the state immediately after the pausing, as shown in FIG. 20B, the intermediate stream that is stored in the first buffer 111 for picture display is used. The reason for not using the pictures which have not been inputted into the coding unit 161 is that such pictures are erased as the coding processing proceeds.

As little time elapses after the pausing as shown in FIG. 20C, a temporal position of the intermediate stream stored in the first buffer 111 is divided into segments. This is because there are a stream necessary for coding and a stream necessary for reproduction of the pictures close to the paused picture.

In the case where the time further passes from the pausing time as shown in FIG. 20D, not only the intermediate stream of a time that is after the pausing time Pa is retained in the second recording area 322 and the first buffer 111, but also the intermediate stream before the pausing time Pa is previously decoded and then stored. This is due to the assumption that in the case where the user restarts the viewing, the user operates back playback in the case of restarting the playback from the temporal position slightly prior to the pausing or operates fast-forward or rewind of the display of the pictures close to the paused picture.

Note that the operation for a reproduction time to catch up with a recording time after the release of pausing can be carried out by the same processing as described in the third embodiment. When the reproduction time deviates from the pausing time Pa, the accumulation area for the stream before and after the pausing time Pa is controlled as an accumulation area for the intermediate stream gets closer to the recording time Re.

Note that the operation described above is not limited to the viewing of the pictures which have not been inputted into the coding unit 161 which are presently being recorded. For example, in the case of viewing TV broadcast that is not being recorded, recording/reproduction of the picture before a paused picture is impossible since the stream prior to the pausing does not exist. However, by starting recording by a pausing operation, it is possible to carry out the same processing for the stream after the pausing operation.

(Fifth Embodiment)

An example of the application of the abovementioned coding/decoding apparatus will be described.

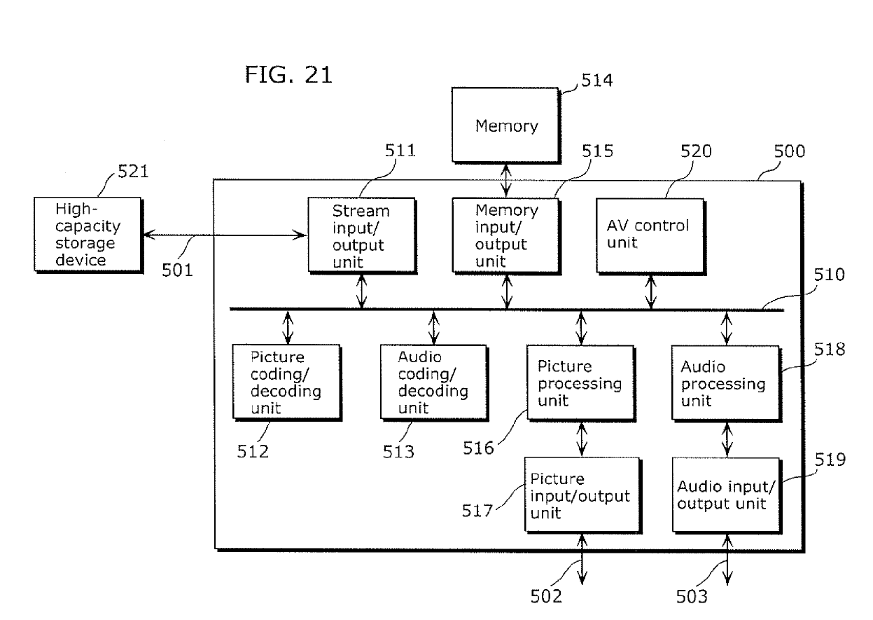

FIG. 21 is a block diagram showing an AV processing unit which realizes an H.264 recorder. As shown in the diagram, an AV processing unit 500 is an AV processing unit, such as a DVD recorder and a hard disk recorder, which reproduces digitally-compressed audio and pictures.

A stream data 501 presents audio and picture stream data, a picture signal 502 is picture stream data, and an audio signal 503 presents audio stream data. A bus 510 transfers stream data, data obtained by decoding audio and pictures. A stream input/output unit 511 is connected to the bus 510 and a high-capacity storage device 521, and inputs and outputs the stream data 501. A picture coding/decoding unit 512 is connected to the bus 510, and performs coding and decoding of the pictures. A memory 514 is a memory in which the stream data, coded data and decoded data are stored.

The picture coding/decoding unit 512 includes the variable length coding unit 1011 the arithmetic coding 102, the arithmetic decoding unit 103 and the variable length decoding unit 104 which are shown in FIG. 4. The stream data 501 includes the final streams 144 and 145 shown in FIG. 4. In addition, the memory 514 includes the first buffer 111, the second buffer 112, the third buffer 113, the fourth buffer 114, and the fifth buffer 215 or the fifth buffer 315. The first recording area 121 of the high-capacity storage device 120 and the second recording area 222 of the high-capacity storage device 220 are included in the high-capacity storage device 521 shown in FIG. 21.

A picture processing unit 516 is connected to the bus 510 and performs pre-processing and post-processing on a picture signal. A picture input/output unit 517 outputs, to the exterior, a picture stream data signal processed by a picture processing unit 516 or a picture stream data signal that has only passed the picture processing unit 516 without being processed, as a picture signal 502, and also takes in the picture signal 502 from the exterior.

An audio processing unit 518 is connected to the bus 510, and performs pre-processing and post-processing on an audio signal. An audio input/output unit 519 outputs, to the exterior, an audio stream data signal processed by the audio processing unit 518 or an audio stream data signal that has only passed the audio processing unit 518 without being processed, as an audio signal 503, and also takes in the audio signal 503 from the exterior. An AV control unit 520 performs overall control on the AV processing unit 500.

In the coding processing, the picture signal 502 is firstly inputted into the picture input/output unit 517, and then, the audio signal 503 is inputted into the audio input/output unit 519.

In the recording processing, the AV control unit 520 controls the picture processing unit 516 to perform processing such as filtering and feature extraction for coding, using the picture signal 502 inputted into the picture input/output unit 517, and to store the resulting data as original picture stream data into the memory 514 via the memory input/output unit 515. Then, the AV control unit 520 controls the picture coding/decoding unit S12 so that the original picture stream data and reference picture stream data are transferred from the memory 514 to the picture coding/decoding unit 512 via the memory input/output unit 515, and the picture stream data coded by the picture coding/decoding unit 512 and the pictures which have not been inputted into the coding unit 161 are transferred, in return, from the picture coding/decoding unit 512 to the memory 514.

The AV control unit 520 controls the audio processing unit 518 to perform processing such as filtering and feature extraction for coding, using the audio signal 503 inputted into the audio input/output unit 519, and to store the resulting data and original audio stream data into the memory 514 via the memory input/output unit 515. Then, the AV control unit 520 causes the audio processing unit 518 to take out and code the original audio stream data from the memory 514 via the memory input/output unit 515, and to store the coded audio stream data as audio stream data into the memory 514.

The AV control unit 520 then processes, in the end of the coding processing, the picture stream data, the audio stream data and other stream information as one stream data, outputs the stream data 501 via the stream input/output unit 511, and writes the stream data 501 into the high-capacity storage device 521 such as an optical disk and a hard disk.

The following operation is performed for chasing playback. Firstly, the audio and picture stream data 501 is inputted via the stream input/output unit 511 by reading out the data accumulated in the recording processing from the high-capacity storage device 521 such as an optical disk, a hard disk and a semiconductor memory. Of the stream data 501, the picture stream data is inputted into the picture coding/decoding unit 512 while the audio stream data is inputted into the audio coding/decoding unit 513,

The picture stream data decoded by the picture coding/decoding unit 512 is stored into a temporary memory 514 via the memory input/output unit 515. The data stored in the memory 514 goes through the processing such as noise elimination performed by the picture processing unit 516. The picture stream data stored in the memory 514 may be used again by the picture coding/decoding unit 512 as a reference picture for inter-picture motion compensation prediction.

The audio stream data decoded by the audio coding/decoding unit 513 is stored into the temporary memory 514 via the memory input/output unit 515. The data stored in the memory 514 goes through the processing, e.g., acoustics performed by the audio processing unit 518.

Lastly, while temporally synchronizing the audio and the pictures, the data processed by the picture processing unit 516 is outputted as the picture signal 502 via the picture input/output unit 517, and then displayed on the TV screen, whereas the data processed by the audio processing unit 518 is outputted as the audio signal 503 via the audio input/output unit 519 and outputted from a speaker or the like.

In the chasing playback operation, overall control is carried out so that the recording and reproduction processing as described above are executed at the same time or seemingly at the same time at macro level, by performing the operations through time-sharing.

Note that in the embodiments described above, an intermediate stream to be generated during variable length coding is retained and variable length decoding is performed starting therefrom; however, instead of retaining an intermediate stream, it is possible to perform variable length coding using a totally different variable length coding unit. For example, according to the H.264 standard, since a variable length coding tool of Context-Adaptive Variable Length Coding (CAVLC), different from a CABAC, which does not include arithmetic coding is also specified, it is possible to perform, at the same time, variable length coding using first-type and second-type variable length coding functions and coding using a third type variable length coding function that is CAVLC-compliant and store the coded stream data into the second recording area 222, and furthermore, to perform decoding using a third-type variable length decoding function that is CAVLC-compliant and generate an output syntax 132.

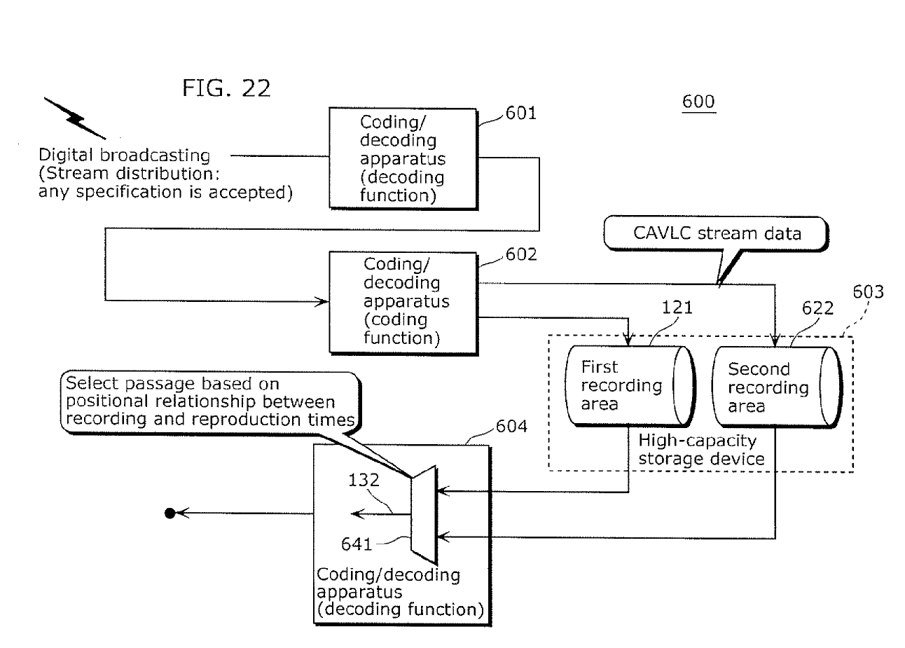

For example, in the case of operating chasing playback as shown in FIG. 22, a coding/decoding apparatus 600 receives the stream data broadcast via digital broadcast and the stream data distributed through stream distribution. The received stream is decoded by a decoding function 601 (see FIG. 7) of the coding/decoding apparatus 600, and the stream data obtained through the decoding is coded by a coding function 602 (see FIG. 6) of the coding/decoding apparatus 600. Here, the coding/decoding apparatus 600, as is the case of the coding/decoding apparatus 200 described in the second embodiment, writes the stream data obtained through processing that requires time, e.g., arithmetic coding, into the first recording area 121, as well as to write the CAVLC stream data into a third recording area 622. The selection unit 641 selects one of the first recording area 121 and the third recording area 622 based on the positional relationship of recording and reproduction times, and a decoding function 604 (see FIG. 7) of the coding/decoding apparatus 600 may decode the stream data recorded in the selected recording area and output the picture data obtained through the decoding.

A stream defined in a different specification such as MPEG-2, and an original stream which does not require sequential processing may be used. Moreover, in the case where digital broadcast compliant with the MPEG-2 or the like is being viewed, it is possible to use, for this purpose, a stream received without coding processing and manage a buffer. In such a case, without arithmetic coding, it is possible to reduce the amount of stream transmission to and from an SDRAM, as well as to allow a reproduction time to catch up with a recording time in chasing playback operation.

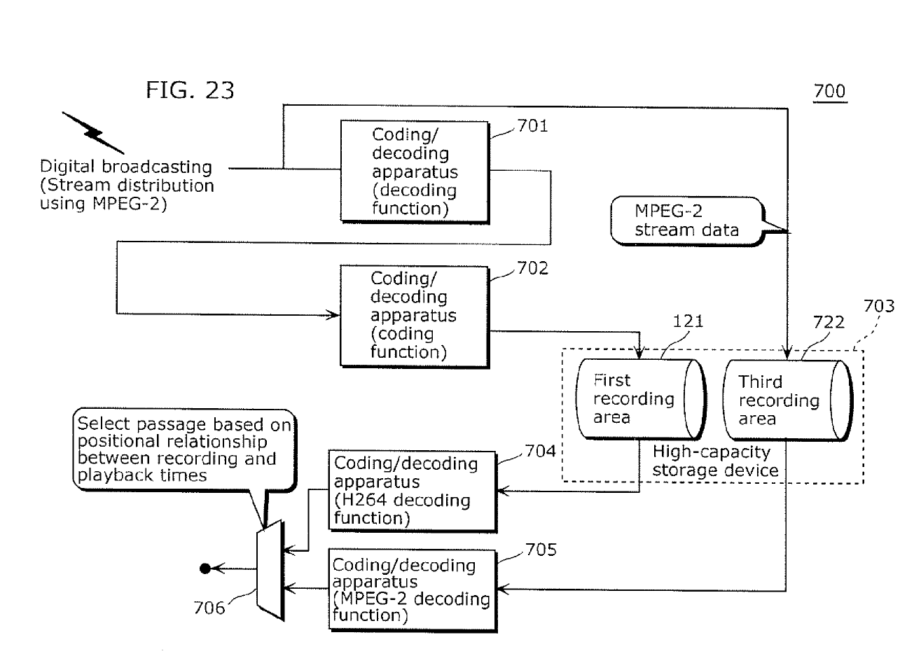

For example, in the case of operating chasing playback, as shown in FIG. 23, a coding/decoding apparatus 700 receives MPEG-2 stream data that is broadcast through digital broadcasting and MPEG-2 stream data distributed through stream distribution. A decoding function 701 (see FIG. 7) of the coding/decoding apparatus 700 decodes the received MPEG-2 stream data. The stream data obtained through the decoding is coded by a coding function 702 (see FIG. 6) of the coding/decoding apparatus 700. The coding/decoding apparatus 700 writes the coded stream data into the first recording area 121 as well as writes the received MPEG-2 stream data into a third recording area 722 of a high-capacity storage device 703. Then, a selection unit 706 selects one of an H.264 decoding function 704 and an MPEG-2 decoding function 705 based on the positional relationship of recording and reproduction times, and the picture data processed by the selected decoding function is outputted. In this case, the H.264 stream data recorded in the first recording area 121 is processed by the H.264 decoding function 704, and the picture data resulting from the processing is outputted to the selection unit 706. The coding/decoding apparatus 700 may operate so that the MPEG-2 stream data recorded in the third recording area 722 is processed by the MPEG-2 decoding function 705, and the picture data resulting from the processing is outputted to the selection unit 706.

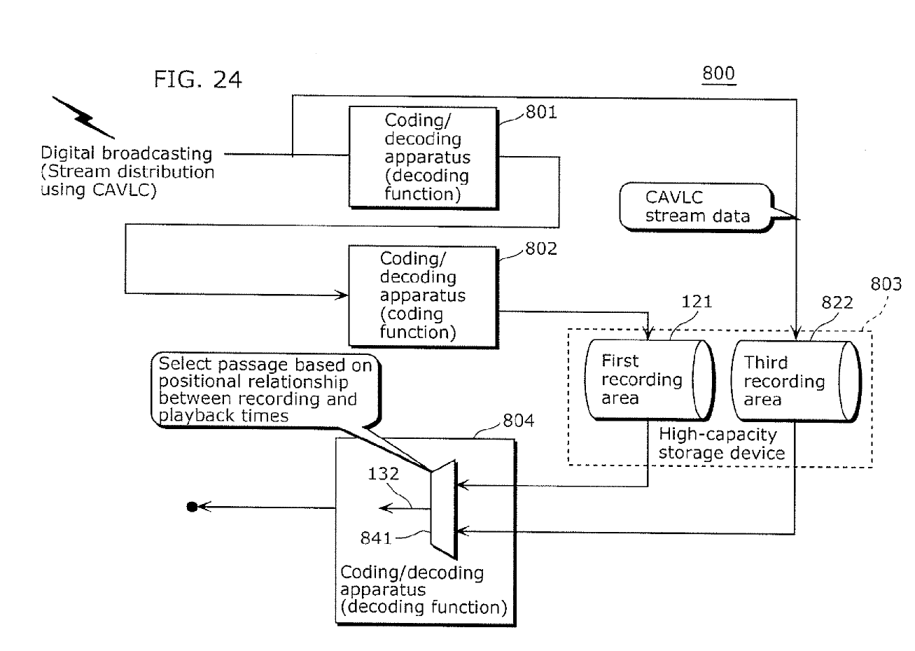

Note that in the case of operating chasing playback as shown in FIG. 24, a coding/decoding apparatus 800 receives CAVLC stream data that is broadcast through digital broadcasting and CAVLC stream data distributed through stream distribution. The received CAVLC stream data is decoded by a decoding function 801 (see FIG. 7) of the coding/decoding apparatus 800. The stream data obtained through the decoding is coded by a coding function 802 (see FIG. 6). The coding/decoding apparatus 800 writes the coded stream data into the first recording area 121 as well as writes the received CAVLC stream data into a third recording area 822 of a high-capacity storage device 803. Then, the coding/decoding apparatus 800 may operate so that a selection unit 841 selects one of the first recording area 121 and a third recording area 822 based on the positional relationship of recording and reproduction times, the decoding function 804 (see FIG. 7) decodes the stream data recorded in the selected recording area, and the picture data obtained through the decoding is outputted.

Note that each function block in the block diagrams (FIGS. 4, 13, 15 and 19) is realized as an LSI that is a typical integrated circuit. These function blocks may be separately implemented into a chip, or some or all of the function blocks may be implemented into one chip. For example, the first recording area 121, the second recording area 222 (or the second recording area 322), the First buffer 111, the second buffer 112, the third buffer 113, the fourth buffer 114 and the fifth buffer 215 (or the fifth buffer 315) may be implemented as one chip. However, the recording area shown in the diagram needs to accumulate an enormous amount of data in Giga byte unit. Therefore, in general, such a recording area is a specified area included in a high-capacity storage device such as a hard disk, a DVD and a memory card. Likewise, the first buffer 111 also needs to hold a huge amount of data; therefore, it is currently common to implement such a buffer with a high-capacity SDRAM that is normally attached externally to an LSI. However, with the progress of technology, a buffer can be possibly implemented as one package or one chip. In addition, the components aside from a buffer and a recording area may be configured as one chip, or as plural chips, for instance, a function related to recording is implemented into one chip while a function related to reproduction is implemented into another chip.

The name used here is LSI, but it may also be called IC, system LSI, super LSI, or ultra LSI depending on the degree of integration. Moreover, ways to achieve integration are not limited to the LSI, and special circuit or general purpose processor and so forth can also achieve the integration, Field Programmable Gate Array (FPGA) that can be programmed after manufacturing LSI or a reconfigurable processor that allows re-configuration of the connection or configuration of LSI can be used for the same purpose. In the future, with the arrival of integration technology which may replace LSI due to the advancement in semiconductor technology or another derivative technology, the integration of the function blocks can be carried out using that technology. Application of biotechnology is one such possibility.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The coding/decoding apparatus of the present invention can render unnecessary processing that includes arithmetic coding for simultaneously operating coding and decoding of pictures. Thus, it is possible to reduce an arithmetic decoding processing step or an amount of data transfer. The present apparatus is therefore effective in order to realize, for example, chasing playback in a DVD recorder or a hard disk recorder compliant with the H.264 standard.

What is claimed is:

1. A coding/decoding apparatus which performs coding and decoding at the same time, said apparatus comprising:
a first-type variable length coding unit operable to perform first-type variable length coding on input data so as to generate first-type stream data, the first-type variable length coding not including an arithmetic coding process;
a second-type variable length coding unit operable to perform second-type variable length coding on the first-type stream data so as to generate second-type stream data, the second-type variable length coding being different from the first-type variable length coding;
a first recording unit operable to record the second-type stream data into a first recording area; and
a first-type variable length decoding unit operable to perform first-type variable length decoding on the first-type stream data so as to generate output data, the first-type variable length decoding being for decoding the first-type stream data into a data format applied before the first-type variable length coding is performed,

2. The coding/decoding apparatus according to claim 1, further comprising
a first buffer memory unit operable to store the first-type stream data generated by said first-type variable length coding unit,
wherein said first-type variable length decoding unit is operable to perform the first-type variable length decoding on the first-type stream data stored in said first buffer memory unit.

3. The coding/decoding apparatus according to claim 2, further comprising:
a second recording unit operable to record the first-type stream data stored in said first buffer memory unit into a second recording area; and
a second buffer memory unit operable to store the first-type stream data recorded in the second recording area,
wherein said first-type variable length decoding unit is operable to perform the first-type variable length decoding on the first-type stream data stored in one of said first buffer memory unit and said second buffer memory unit.

4. The coding/decoding apparatus according to claim 3, further comprising:
a second-type variable length decoding unit operable to perform second-type variable length decoding on the second-type stream data so as to generate first-type stream data, the second-type variable length decoding being for decoding the second-type stream data into a data format applied before the second-type variable length coding is performed; and
a third buffer memory unit operable to store the first-type stream data generated by said second-type variable length decoding unit,
wherein said first-type variable length decoding unit is operable to perform the first-type variable length decoding on the first-type stream data stored in one of said first buffer memory unit, said second buffer memory unit and said third buffer memory unit.

5. The coding/decoding apparatus according to claim 4, further comprising:
a selection unit operable to select a supplier of the first-type stream data inputted into said first-type variable length decoding unit; and
a selection control unit operable to cause said selection unit to select a supplier based on a temporal relationship between a recording time and a reproduction time.

6. The coding/decoding apparatus according to claim 5,
wherein said selection control unit is operable to cause said selection unit (a) to select said third buffer memory unit as the supplier when reproduction processing is started during recording processing, (b) to select said second buffer memory unit as the supplier as the reproduction time approaches to the recording time, and (c) to select said first buffer memory unit as the supplier as the reproduction time further approaches the recording time.

7. The coding/decoding apparatus according to claim 2, further comprising:
a second-type variable length decoding unit operable to perform second-type variable length decoding on the second-type stream data so as to generate the first-type stream data, the second-type variable length decoding being for decoding a data format of the second-type stream data into a data format applied before the second-type variable length coding is performed; and
a second buffer memory unit operable to store the first-type stream data generated by said second-type variable length decoding unit,
wherein said first-type variable length decoding unit is operable to perform the first-type variable length decoding on the first-type stream data stored in one of said buffer memory unit and said second buffer memory unit.

8. The coding/decoding apparatus according to claim 1, further comprising:
a second recording unit operable to record the first-type stream data into a second recording area; and
a first buffer memory unit operable to store the first-type stream data recorded in the second recording area,
wherein said first-type variable length decoding unit is operable to perform the first-type variable length decoding on the first-type stream data stored in said first buffer memory unit.

9. The coding/decoding apparatus according to claim 8, further comprising:
a second-type variable length decoding unit operable to perform second-type variable length decoding on the second-type stream data so as to generate first-type stream data, the second-type variable length decoding being for decoding the second-type stream data to obtain a data format applied before the second variable length coding is performed; and
a second buffer memory unit operable to store the first-type stream data generated by said second-type variable length decoding unit,
wherein said first-type variable length decoding unit is operable to perform the first-type variable length decoding on the first-type stream data stored in one of said first buffer memory unit and said second buffer memory unit.

10. The coding/decoding apparatus according to claim 1,
wherein said second-type variable length coding unit is operable to perform, per unit, sequential processing as the second-type variable length coding the unit being smaller than a coded symbol that constitutes the first-type stream data.

11. The coding/decoding apparatus according to claim 10, further comprising:
a third-type variable length coding unit operable to perform third-type variable length coding on input data so as to generate third-type stream data, the third-type variable length coding not requiring the sequential processing;
a third recording unit operable to record the third-type stream data generated by said third-type variable length coding unit into a third recording area; and
a third-type variable length decoding unit operable to perform third-type variable length decoding on the third-type stream data recorded in the third recording area, so as to generate output data, the third-type variable length decoding being for decoding the third-type stream data into a data format applied before the third-type variable length coding is performed.

12. The coding/decoding apparatus according to claim 11, further comprising:
a selection unit operable to select one of said first-type variable length decoding unit and said third-type variable length decoding unit as a supplier of the output data; and
a selection control unit operable to cause said selection unit to select the supplier based on a temporal relationship between a recording time and a reproduction time.

13. The coding/decoding apparatus according to claim 12,
wherein said selection control unit is operable to cause said selection unit (a) to select said first-type variable length decoding unit as the supplier when reproduction processing is started during recording processing, and (b) to select said third-type variable length decoding unit as the supplier as the reproduction time approaches to the recording time.

14. The coding/decoding apparatus according to claim 10,
wherein said second-type variable length coding unit is operable to perform arithmetic coding as the sequential processing.

15. The coding/decoding apparatus according to claim 10,
wherein in the case where the input data is generated from third-type stream data which does not require the sequential processing,
said coding/decoding apparatus further comprises:
a third recording unit operable to record the third-type stream data into a third recording area; and
a third-type stream data decoding unit operable to decode the third-type stream data recorded in the third recording area, so as to generate output data.

16. The coding/decoding apparatus according to claim 1, further comprising:
a first buffer memory unit operable to store the first-type stream data generated by said first-type variable length coding unit;
a selection unit operable to select an output destination of the first-type stream data stored in said first buffer memory unit; and
a selection control unit operable to control said selection unit to select the output destination based on a temporal relationship between a recording time and a reproduction time.

17. The coding/decoding apparatus according to claim 16, further comprising
a second recording unit operable to record the first-type stream data stored in said first buffer memory unit into a second recording area,
wherein said selection control unit is operable to control said first buffer memory unit and said second recording unit so that the first-type stream data of a time which is closer to the recording time is preferentially retained.

18. The coding/decoding apparatus according to claim 16, further comprising
a second recording unit operable to record the first-type stream data stored in said first buffer memory unit into a second recording unit,
wherein said selection control unit is operable to control said first buffer memory unit and said second recording unit so that the first-type stream data of a time which is closer to a pausing time is preferentially retained.

19. The coding/decoding apparatus according to claim 1, further comprising:
a selection unit operable to select a supplier of the first-type stream data inputted into said first-type variable length decoding unit; and
a selection control unit operable to cause said selection unit to select the supplier based on a temporal relationship between a recording time and a reproduction time.

20. A coding/decoding method for performing coding and decoding at the same time, said method comprising:
performing first-type variable length coding on input data so as to generate first-type stream data, the first-type variable length coding not including an arithmetic coding process;
performing second-type variable length coding on the first-type stream data so as to generate second-type stream data, the second-type variable length coding being different from the first-type variable length coding;
recording the second-type stream data into a first recording area; and
performing first-type variable length decoding on the first-type stream data so as to generate output data, the first-type variable length decoding being for decoding the first-type stream data into a data format applied before the first-type variable length coding is performed.

21. A coding/decoding integrated circuit which performs coding and decoding at the same time, said coding/decoding integrated circuit comprising:
a first-type variable length coding unit operable to perform first-type variable length coding on input data so as to generate first type stream data, the first-type variable length coding not including an arithmetic coding process;
a second-type variable length coding unit operable to perform second-type variable length coding on the first-type stream data so as to generate second-type stream data, the second-type variable length coding being different from the first-type variable length coding;
a first recording unit operable to record the second-type stream data into a first recording area; and
a first-type variable length decoding unit operable to perform first-type variable length decoding on the first-type stream data so as to generate output data, the first-type variable length decoding being for decoding the first-type stream data into a data format applied before the first-type variable length coding is performed.

22. A coding/decoding program for performing coding and decoding at the same time, said program causing a computer system to execute the steps of:
performing first-type variable length coding on input data so as to generate first-type stream data, the first-type variable length coding not including an arithmetic coding process;
performing second-type variable length coding on the first-type stream data so as to generate second-type stream data, the second-type variable length coding being different from the first-type variable length coding;
recording the second-type stream data into the first recording area; and
performing first-type variable length decoding on the first-type stream data so as to generate output data, the first-type variable length decoding being for decoding the first-type stream data into a data format applied before the first-type variable length coding is performed.
